(19) United States
(12) Patent Application Publication
(10) Pub. No.: US 2004/0010504 A1
(43) Pub. Date: Jan. 15, 2004

(54) Custom sequence databases and methods of use thereof

(76) Inventors: Steven H. Hinrichs, Omaha, NE (US); Amr M. Mohamed, Omaha, NE (US); Hesham Ali, Omaha, NE (US); Dan Kuyper, Omaha, NE (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/438,774

(22) Filed: May 14, 2003

Related U.S. Application Data
(60) Provisional application No. 60/381,015, filed on May 15, 2002.

(51) Int. Cl. G06F 7/00

(52) U.S. Cl. 707/100

(57) ABSTRACT

Methods are provided for generating, building, updating, and searching a custom database of biological sequences. Methods for differentiating between M. tuberculosis and M. bovis and detecting pyrazinamide (PZA) resistance are also provided.

This invention claims priority under 35 U.S.C. §119 (e) to U.S. Provisional Application No. 60/381,015 filed May 15, 2002. The entire disclosure of the above-identified application is incorporated by reference herein.

### FIELD OF THE INVENTION

The present invention relates to generating, building, and updating a custom database of biological sequences. The present invention also provides methods for utilizing the custom database for the identification of an unknown sample. Methods for differentiating between M. tuberculosis and M. bovis and detecting pyrazinamide (PZA) resistance are also provided.

### BACKGROUND OF THE INVENTION

All publications, patent applications, patents, and other references mentioned herein are incorporated by reference in their entirety.

The identification of unknown genetic sequences is a key problem facing biological researchers. This problem is complicated by the sheer size of sequencing data available and the tools available to analyze the data.

The GenBank® database, maintained by The National Center for Biotechnology Information (NCBI), contains all known nucleotide and protein sequences with supporting bibliographical and biological information (Benson, D. A., et al. (2000) Nuc. Acid Res. 28:15-18). The data provided by GenBank is valuable, but not without pitfalls. For one, the sheer size of GenBank makes certain operations, such as running optimal alignment algorithms, impossible due to time constraints. Therefore, heuristics such as BLAST® (Basic Local Alignment Search Tool) and FASTA must be employed. A second pitfall is the quality of GenBank data. Although attempts are made to control quality through certain mechanisms, it is impossible to ensure good or complete data due to numerous factors such as sequencing errors in submitted information, improperly or ambiguously named sequences, and contamination due to sequences intentionally or accidently inserted during cloning or recombination (Bork, P. And A. Bairoch (1996) Trends Genet. 12:425-427).

The most common tool used in genetic database searches is BLAST. BLAST is a heuristic tool which finds the highest scoring local alignments between a query and a sequence in a database (Altschul, S. F., et al. (1990) J. Mol. Biol. 215:403-410). Although BLAST is very fast and useful in many cases, some drawbacks exist. The most significant of these drawbacks is the potential to generate biologically unimportant information. Since BLAST is only a heuristic, researchers must still determine whether identified sequences constitute a true “hit”. Therefore, BLAST can be considered a good starting point, but not an end point in the sequence identification process.

The ability to generate manageable custom databases that are readily updated and searchable by algorithms rather than heuristics would meet the shortcomings of the GenBank and BLAST system.

### SUMMARY OF THE INVENTION

In accordance with the present invention, methods are provided for generating and updating a custom database. The methods comprise creating and naming a database container; defining sequence regions wherein each region has a highly conserved start and end pattern; assigning characteristics (i.e. validation conditions) to each region; and adding sequences that have passed the validation conditions to the custom database.

In one aspect of the instant invention, the validation conditions for generating the custom database include, without limitation, a threshold for wildcards allowed when updating or adding a sequence; a threshold for wildcards allowed in an unknown sequence during the search process; characters constituting wildcards; a limit of the number of characters in a character run; and a requirement for the presence of the highly conserved start and end patterns.

In yet another aspect of the invention, the sequences to be added to the custom database are obtained from an external database. Preferably, the external database is GenBank. The custom database can be updated with sequences manually or automatically and at periodic intervals to keep the database current.

In another embodiment of the invention, the sequences to be added to the custom database are obtained from sequencing from the genome of isolates that are identified by biological identification techniques. Primer sets are provided for the amplification of specific regions within Mycobacterium.

In another aspect of the instant invention, methods of searching the custom database to identify an unknown sample are also provided. The methods comprise obtaining a sequence from an unknown sample; selecting the custom database sequence regions to be searched; validating the unknown sequence against the custom database validation conditions; returning an error message if the unknown sequence fails the validation conditions; computing similarity scores for each selected region of the unknown sequence against regions for each active sequence in the custom database if the input sequence is valid; sorting the similarity scores from highest to lowest; and outputting results and displaying region alignments.

In yet another embodiment of the invention, compositions and methods are provided for differentiating between M. tuberculosis and M. bovis and determining the pyrazinamide (PZA) resistance status of a sample.

In another aspect of the instant invention, a method for determining the PZA resistance status of a Mycobacterium and identifying a sample as M. tuberculosis or M. bovis in a biological sample is provided. The method comprising obtaining a sample suspected of containing M. tuberculosis or M. bovis, amplifying a nucleic acid comprising the pcnA gene region from said sample, mixing the amplified nucleic acid with a M. tuberculosis probe and with a M. bovis probe such that hybridization occurs and forms polynucleotide complexes; subjecting formed complexes to denaturing high performance liquid chromatography; and analyzing the peak pattern of the eluates to determine the PZA resistance status of said Mycobacterium sample and whether said sample is M. tuberculosis or M. bovis.

### BRIEF DESCRIPTION OF THE DRAWINGS

FIG. 1 is a flow chart which depicts the methods of generating, updating, and searching a custom database.

FIG. 2 provides an example of a validation algorithm.

FIG. 3 is a flow chart depicting the BioDatabase application.

FIG. 4 is an alignment of M. intercellularae Mac-A (SEQ ID NO: 12) from the custom database (BioDatabase) and an input sequence (SEQ ID NO: 13).

FIG. 5 is an alignment of M. intercellularae Mac-A (SEQ ID NO: 14) from the GenBank database (as performed by BLAST) and an input sequence (SEQ ID NO: 13). Arrow indicates bases that differed from the custom database and the GenBank database.

FIGS. 6A through 6D demonstrate the usage of the BioDatabase. FIG. 6A depicts an interface with the BioDatabase wherein an input sequence (SEQ ID NO: 15) is to be compared with the database using only the 16S rRNA gene region. FIG. 6B depicts the results of the search of the BioDatabase as detailed in FIG. 6A. FIG. 6C depicts an input sequence (SEQ ID NO: 16) to be searched against only the ITS region of the BioDatabase. FIG. 6D displays the results of the search depicted in FIG. 6C.

FIGS. 7A through 7D demonstrate the usage of the BioDatabase. FIG. 7A depicts an interface with the BioDatabase wherein an input sequence (SEQ ID NO: 17) is to be compared with the database using only the 16S rRNA gene region. FIG. 7B depicts the results of the search of the BioDatabase as detailed in FIG. 7A. FIG. 7C depicts an input sequence (SEQ ID NO: 18) to be searched against only the ITS region of the BioDatabase. FIG. 7D displays the results of the search depicted in FIG. 7C.

FIG. 8 provides the universal gradient buffer concentrations and program for mutation detection and the modified gradient buffer concentrations for pncA gene mutation detection.

FIG. 9 provides the proposed protocol for the identification of test isolates as M. tuberculosis or M. bovis and simultaneous identification of PZA susceptibility through the use of two different reference probes.

FIG. 10 shows an alignment of the pncA gene and its putative promotor of wild type M. tuberculosis (SEQ ID NO: 19) and M. bovis (SEQ ID NO: 20) showing the position of the 13 different mutant strains used in the study; mutant 1 (G₂₃₃A), mutant 2 (C₂₉₇G), mutant 3 (del G₇₁), mutant 4 (A₄₁₀G) , mutant 5 (T₁₁C) , mutant 6 (T₋₀₇C), mutant 7 (A₂₉C) , mutant 8 (A₁₃₉G) , mutant 9 (T₃₉₈A) , mutant 10 (T₅₁₅C) , mutant 11 (A₁₅₂C) , mutant 12 (C₁₈₅G) , and mutant 13 (C₄₅₈A). * identifies the unique mutation of M.bovis (C₁₆₉G) that convey natural PZA resistance.

FIGS. 11A and 11B depict the TMHA of pncA gene PCR product from reference control and test wild type isolates using the M.tuberculosis reference probe (FIG. 11A) and the M.bovis reference probe (FIG. 11B). Chromatographic patterns a and b in each panel depict the wild type reference control isolates of M. tuberculosisand M.bovis with the reference probes, respectively. Chromatographic patterns 1, 3 and 5 are three representative wild type M. tuberculosis test isolates and patterns 2, 4 and 6 are three representative M.bovis test isolates.

FIGS. 12A and 12B depict the TMHA of pncA gene PCR product from reference control and test mutant isolates using the M.tuberculosis reference probe (FIG. 12A) and the M.bovis reference probe (FIG. 12B). Chromatographic patterns a and b in each panel depict the wild type reference control isolates of M.tuberculosis and M.bovis with the reference probes respectively. Chromatographic patterns 1-13 in each panel depict the 13 test mutant isolates with each of the reference probes. All mutant isolates demonstrated the predicted double peak patterns with both probes with the exception of mutant 3 and mutant 9 (circled).

FIG. 13A depicts the TMHA of pncA gene PCR product of mutant isolates 3 and 9 with the M. tuberculosis reference probe. The chromatographs show the difference in shape between the patterns obtained by mutant isolates 3 (Mut.3) and 9 (Mut.9) in comparison with that of wild type M.tuberculosis (WT). FIG. 13B depicts the TMHA of pncA gene PCR product of mutant isolates 3 and 9 with the M.bovis reference probe. Differences in retention time between the double peak patterns of mutant isolates 3 and 9 (Mut.3) and (Mut.9) in comparison with that of wild type M.tuberculosis (WT) is illustrated.

FIG. 14 depicts the TMHA of pncA gene PCR product from reference control and test mutant isolates using the M.tuberculosis ΔA₋₄₂ mutant probe. Chromatographic pattern W in the first panel depicts the wild type reference control isolates of M.tuberculosis with the mutant probe. Chromatographic patterns 1-15 depict the 15 test mutant isolates with the mutant probe (isolates 1-13 are the same as 1-13 in FIG. 12, isolates 14 and 15 are two additional PZA resistant M. tuberculosis isolates). All mutant isolates demonstrated the predicted double peak patterns with the mutant probe including mutant 3 and mutant 9 (shaded circle). Notably, only a single peak was noted with the wild-type isolate (shaded box).

FIG. 15 provides the sequence of SEQ ID NO: 21.

### DETAILED DESCRIPTION OF THE INVENTION

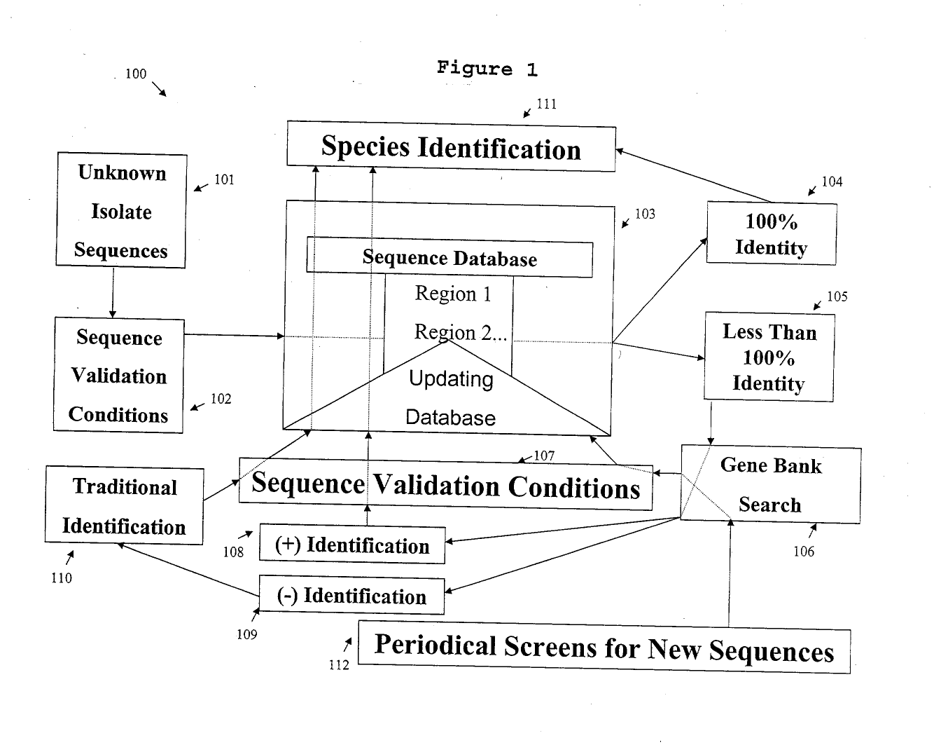

The instant invention provides methods, and more particularly computer-executed methods, for the generation of a custom database, updating of the database, and searching unknown samples against the database. FIG. 1 provides a flow chart (100) which generalizes a certain embodiment of the instant invention. Briefly, a sequence from an unknown isolate is obtained (101) and is checked against the sequence validation conditions (102) set for the custom database. If the unknown sequence meets the validation conditions, it can be searched against any of the various regions within the custom database (103). Unknown sequences that do not meet the validation condition are discarded. If the search against the custom database yields a 100% identity match (104), then the species has been identified (111). If the search against the database yields a match that is less than 100% identical (105), then the unknown sequence can be searched against an external database, e.g. GenBank (106). If the sequence is positively identified (108) in the GenBank search, the obtained sequence is subjected to the validation conditions (107) of a custom database. Notably, the 102 validation conditions may be different than the 107 validation conditions. Upon validation of the sequence, the obtained sequence will be entered into the custom database (103) and the original unknown sequence will have been identified (111). If the sequence is not positively identified (109) in the GenBank search (106), traditional biochemical identification processes (110) are performed on the unknown isolate. Upon identification of the isolate, the unknown sequence is validated against the conditions set forth for the custom database (107). Upon validation of the sequence, the obtained sequence will be entered into the custom database (103) and the original unknown sequence will have been identified (111). Additionally, periodical screens for new sequences (112) may be performed to keep the custom database current. Upon the searching of external databases, e.g. GenBank (106), identified sequences of interest are checked against the validation conditions set forth for the custom database (107). Upon validation of the sequence, the obtained sequence will be entered into the custom database (103). The steps of generating, updating, and searching a custom database are described in detail hereinbelow.

The present invention also encompasses kits for use in searching a custom database. Such kits may comprise a custom database in computer-readable form such as, but not limited to: CD, CD-ROM, floppy disk, and the like. The custom database may also be available in electronic form such as in a downloadable form from a website. The kit may also contain primer sets to allow for the amplification of the nucleic acid sequence to be searched against the custom database. Furthermore, the kit may also comprise a polymerase enzyme suitable for use in PCR and suitable buffers for the amplification of the DNA region bracketed by the primer set. Additionally, the kit may contain nucleic acid purification reagents such as those provided in the QIAmp Blood Kit (Qiagen Inc., Valencia, Calif.). The kit may further comprise lysis buffer suitable for lysing bacteria in the biological sample, such that DNA is released from the bacteria upon exposure to said buffer.

The kit may further comprise an instructional manual. As used herein, an “instructional material” includes a publication, a recording, a diagram, or any other medium of expression which can be used to communicate the usefulness of the composition of the invention for performing a method of the invention. The instructional material of the kit of the invention can, for example, be affixed to a container which contains a kit of the invention to be shipped together with a container which contains the kit. Alternatively, the instructional material can be shipped separately from the container with the intention that the instructional material and kit be used cooperatively by the recipient.

In another embodiment of the instant invention, methods for differentiating between M. tuberculosis and M. bovis and detecting pyrazinamide (PZA) resistance are provided.

The present invention also encompasses kits for use in the rapid identification of an isolate as M. tuberculosis or M. bovis and determining the pyrazinamide (PZA) resistance status of the isolate. The kit may contain any combination of the following: 1)a primer set, having the sequence of SEQ ID NO: 9 and SEQ ID NO: 10, 2) lysis buffer suitable for lysing bacteria in the biological sample, such that DNA is released from the bacteria upon exposure to said buffer, 3) reagents for DNA purification such as those provided in the QIAmp Blood Kit (Qiagen Inc.), 4) buffers for performing DHPLC as described hereinbelow including without limitation: Buffer A, Buffer B, and Buffer D, 5) a column suitable for performing the DHPLC as described hereinbelow and 6) at least one probe comprising SEQ ID NOS: 19, 20, and/or 21. The kit may also comprise an instruction manual.

The following descriptions set forth the general procedures involved in practicing the present invention. To the extent that specific materials are mentioned, it is merely for purposes of illustration and not intended to limit the invention. Unless otherwise specified, general biochemical and molecular biological procedures, such as those set forth in Sambrook et al., Molecular Cloning, Cold Spring Harbor Laboratory (1989) (hereinafter “Sambrook et al.”) or Ausubel et al. (eds) Current Protocols in Molecular Biology, John Wiley & Sons (1997) (hereinafter “Ausubel et al.”) are used.

I. Definitions:

The following definitions are provided to facilitate an understanding of the present invention:

“Nucleic acid” or a “nucleic acid molecule” as used herein refers to any DNA (e.g., cDNA, genomic DNA) or RNA molecule or fragment thereof, either single or double stranded and, if single stranded, the molecule of its complementary sequence in either linear or circular form. In discussing nucleic acid molecules, a sequence or structure of a particular nucleic acid molecule may be described herein according to the normal convention of providing the sequence in the 5′ to 3′ direction. With reference to nucleic acids of the invention, the term “isolated nucleic acid” is sometimes used. This term, when applied to DNA, refers to a DNA molecule that is separated from sequences with which it is immediately contiguous in the naturally occurring genome of the organism in which it originated. For example, an “isolated nucleic acid” may comprise a DNA molecule inserted into a vector, such as a plasmid or virus vector, or integrated into the genomic DNA of a prokaryotic or eukaryotic cell or host organism.

When applied to RNA, the term “isolated nucleic acid” refers primarily to an RNA molecule encoded by an isolated DNA molecule as defined above. Alternatively, the term may refer to an RNA molecule that has been sufficiently separated from other nucleic acids with which it would be associated in its natural state (i.e., in cells or tissues). An “isolated nucleic acid” (either DNA or RNA) may further represent a molecule produced directly by biological or synthetic means and separated from other components present during its production.

The term “oligonucleotide” as used herein refers to sequences, primers and probes of the present invention, and is defined as a nucleic acid molecule comprised of two or more ribo- or deoxyribonucleotides, preferably more than three. The exact size of the oligonucleotide will depend on various factors and on the particular application and use of the oligonucleotide.

The phrase “specifically hybridize” refers to the association between two single-stranded nucleic acid molecules of sufficiently complementary sequence to permit such hybridization under pre-determined conditions generally used in the art (sometimes termed “substantially complementary”). In particular, the term refers to hybridization of an oligonucleotide with a substantially complementary sequence contained within a single-stranded DNA or RNA molecule of the invention, to the substantial exclusion of hybridization of the oligonucleotide with single-stranded nucleic acids of non-complementary sequence. One common formula for calculating the stringency conditions required to achieve hybridization between nucleic acid molecules of a specified sequence homology (Sambrook et al., 1989) is as follows:

Tₘ=81.5° C.+16.6Log[Na+]+0.41(% G+C)−0.63(% formamide)−600/#bp in duplex

As an illustration of the above formula, using [Na+]=[0.368] and 50% formamide, with GC content of 42% and an average probe size of 200 bases, the Tₘ is 57° C. The Tₘ of a DNA duplex decreases by 1-1.5° C. with every 1% decrease in homology. Thus, targets with greater than about 75% sequence identity would be observed using a hybridization temperature of 42° C.

For example, hybridizations may be performed, according to the method of Sambrook et al., Molecular Cloning, Cold Spring Harbor Laboratory (1989), using a hybridization solution comprising: 5×SSC, 5× Denhardt's reagent, 1.0% SDS, 100 μg/ml denatured, fragmented salmon sperm DNA, 0.05% sodium pyrophosphate and up to 50% formamide. Hybridization is carried out at 37-42° C. for at least six hours. Following hybridization, filters are washed as follows: (1) 5 minutes at room temperature in 2×SSC and 1% SDS; (2) 15 minutes at room temperature in 2×SSC and 0.1% SDS; (3) 30 minutes-1 hour at 37° C. in 1× SSC and 1% SDS; (4) 2 hours at 42-65° C. in 1×SSC and 1% SDS, changing the solution every 30 minutes.

The term “probe” as used herein refers to an oligonucleotide, polynucleotide or nucleic acid, either RNA or DNA, whether occurring naturally as in a purified restriction enzyme digest or produced synthetically, which is capable of annealing with or specifically hybridizing to a nucleic acid with sequences complementary to the probe. A probe may be either single-stranded or double-stranded. The exact length of the probe will depend upon many factors, including temperature, source of probe and method of use. For example, for diagnostic applications, depending on the complexity of the target sequence, the oligonucleotide probe typically contains 15-25 or more nucleotides, although it may contain fewer nucleotides. The probes herein are selected to be “substantially” complementary to different strands of a particular target nucleic acid sequence. This means that the probes must be sufficiently complementary so as to be able to “specifically hybridize” or anneal with their respective target strands under a set of pre-determined conditions. Therefore, the probe sequence need not reflect the exact complementary sequence of the target. For example, a non-complementary nucleotide fragment may be attached to the 5′ or 3′ end of the probe, with the remainder of the probe sequence being complementary to the target strand. Alternatively, non-complementary bases or longer sequences can be interspersed into the probe, provided that the probe sequence has sufficient complementarity with the sequence of the target nucleic acid to anneal therewith specifically.

The term “primer” as used herein refers to an oligonucleotide, either RNA or DNA, either single-stranded or double-stranded, either derived from a biological system, generated by restriction enzyme digestion, or produced synthetically which, when placed in the proper environment, is able to functionally act as an initiator of template-dependent nucleic acid synthesis. When presented with an appropriate nucleic acid template, suitable nucleoside triphosphate precursors of nucleic acids, a polymerase enzyme, suitable cofactors and conditions such as appropriate temperature and pH, the primer may be extended at its 3′ terminus by the addition of nucleotides by the action of a polymerase or similar activity to yield a primer extension product. The primer may vary in length depending on the particular conditions and requirement of the application. For example, in diagnostic applications, the oligonucleotide primer is typically 15-25 or more nucleotides in length. The primer must be of sufficient complementarity to the desired template to prime the synthesis of the desired extension product, that is, to be able to anneal with the desired template strand in a manner sufficient to provide the 3′ hydroxyl moiety of the primer in appropriate juxtaposition for use in the initiation of synthesis by a polymerase or similar enzyme. It is not required that the primer sequence represent an exact complement of the desired template. For example, a non-complementary nucleotide sequence may be attached to the 5′ end of an otherwise complementary primer. Alternatively, non-complementary bases may be interspersed within the oligonucleotide primer sequence, provided that the primer sequence has sufficient complementarity with the sequence of the desired template strand to functionally provide a template-primer complex for the synthesis of the extension product.

Polymerase chain reaction (PCR) has been described in U.S. Pat. Nos. 4,683,195, 4,800,195, and 4,965,188, the entire disclosures of which are incorporated by reference herein.

The terms “percent similarity”, “percent identity” and “percent homology” when referring to a particular sequence are used as set forth in the University of Wisconsin GCG software program.

The term “substantially pure” refers to a preparation comprising at least 50-60% by weight of a given material (e.g., nucleic acid, oligonucleotide, protein, etc.). More preferably, the preparation comprises at least 75% by weight, and most preferably 90-95% by weight of the given compound. Purity is measured by methods appropriate for the given compound (e.g. chromatographic methods, agarose or polyacrylamide gel electrophoresis, HPLC analysis, and the like).

The term “functional” as used herein implies that the nucleic or amino acid sequence is functional for the recited assay or purpose.

The phrase “consisting essentially of” when referring to a particular nucleotide or amino acid means a sequence having the properties of a given SEQ ID NO. For example, when used in reference to an amino acid sequence, the phrase includes the sequence per se and molecular modifications that would not affect the basic and novel characteristics of the sequence.

The phrase “internal database” refers to a database which contains biomolecular sequences and may also contain information associated with the sequences such as, without limitation, libraries in which a given sequence is found or not found, descriptive information about a likely gene associated with the sequence, the position of the sequence in its organism's genome, and the organism from which the sequence is derived from. The database may be divided into two parts: one for storing the sequences themselves and the other for storing the associated information. The internal database may sometimes be referred to as a “local” database. The internal database may be maintained as a private database behind a firewall within an enterprise. Alternatively, the internal database could also be made available to the public (e.g. through a website interface or as a kit). Examples of private internal databases include the LifeSeq™ and PathoSeq™ databases available from Incyte Pharmaceuticals, Inc. of Palo Alto, Calif.

The phrase “sequence database” refers to a database which contains sequences of biomolecules.

The phrase “genomic database” refers to a database which contains genomic information about the sequences in the sequence database. Such information may include, without limitation, genomic libraries in which a given sequence is found or not found, descriptive information about a likely gene associated with the sequence, the position of the sequence in its organism's genome, and the organism from which the sequence is derived from.

The phrase “external database” refers to a database located outside the internal database. Typically, it will be maintained by an enterprise that is different from the enterprise maintaining the internal database. The external database is used primarily to obtain new sequences for entry into the internal database. Examples of such external databases include the GenBank database maintained by the National Center for Biotechnology Information (NCBI; part of the National Library of Medicine) and the TIGR database maintained by The Institute for Genomic Research.

The term “library”, as used herein, typically refers to an electronic collection of sequence data.

The term “BLAST” refers to The Basic Local Alignment Search Tool which is a technique for detecting ungapped sub-sequences that match a given query sequence.

The term “FASTA” refers to modular set of sequence comparison programs used to compare an amino acid or DNA sequence against all entries in a sequence database. FASTA was written by Professor William Pearson of the University of Virginia Department of Biochemistry. The program uses the rapid sequence algorithm described by Lipman and Pearson (1988) and the Smith-Waterman sequence alignment protocol. FASTA performs a protein to protein comparison.

The term “Entrez” refers to the text-based search and retrieval system used at NCBI for all of the major databases including: PubMed (biomedical literature database), GenBank, Protein structures (three-dimensional macrolmolecule structures), Protein (amino acid sequences), Genomes (complete genome assemblies), and Taxonomy (organisms in GenBank) and others (see www.ncbi.nlm.nih.gov/Entrez/).

The phrase “highly conserved” refers to nucleotide sequence or regions thereof that have a sequence identity of at least 90%, at least 95%, or preferably 100%. Typically, the regions that are highly conserved are at least about 3, 5, 7, 10, 15, 20, 20, 25, 30, 40, 50, or more nucleotides in length.

II. Generating Custom Database

The steps typically employed in generating a custom internal database include the following:

1) creating and naming a database container;

2) defining sequence regions wherein each region has a highly conserved start and end pattern;

3) assigning characteristics to each region wherein the characteristics may include, without limitation:

a) a threshold for wildcards (e.g. due to sequencing errors) allowed when updating or adding a sequence;

b) a threshold for wildcards (e.g. due to sequencing errors) allowed in an unknown sequence during the search process;

c) characters constituting wildcards (e.g. nucleotides not explicitly determined by sequencing such as ‘N’ (any), ‘H’ (A, C, T), and the like); and

d) limit of character runs which are often representative of sequencing errors (e.g., 7 adenosines in a row); and

4) adding sequences that have passed selected validation conditions, such as the above conditions, to the custom database, either manually or through automated retrieval and insertion.

The inclusion of two separate thresholds for wildcards allows data residing in the database to remain “clean” (i.e., with minimal or no errors) while allowing unknown sequences to be searched against the database to be of a lower quality (i.e., contain wildcards).

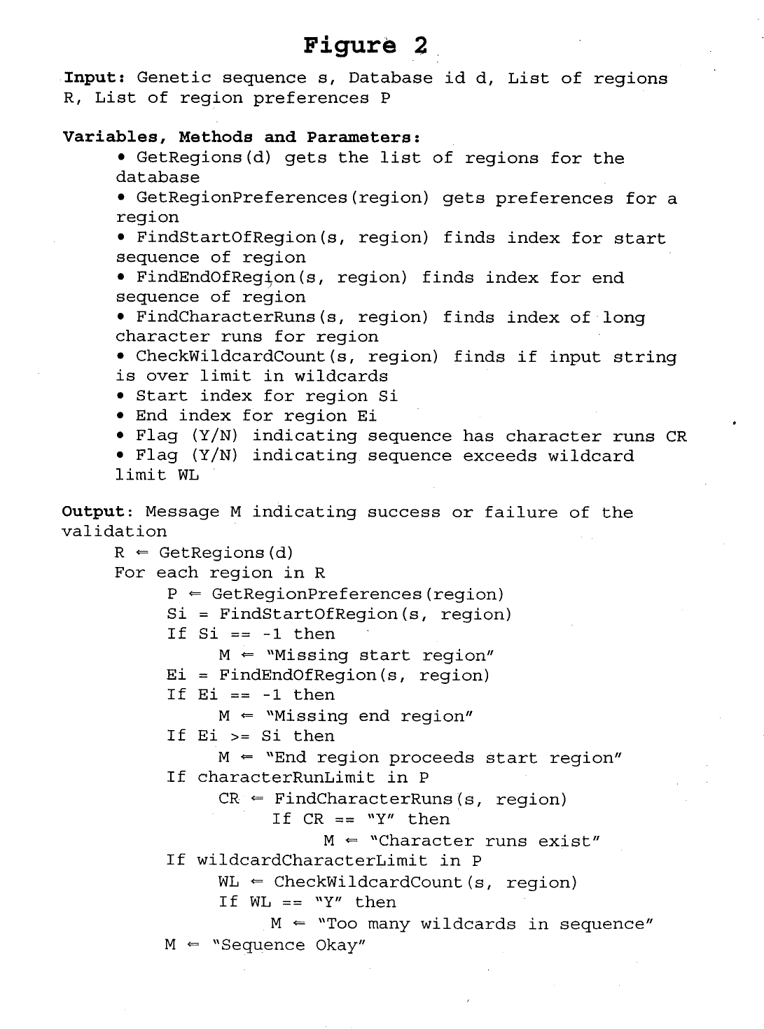

In a preferred embodiment, an algorithm is employed to determine whether a sequence meets the validation conditions associated with the custom database. An example of such a validation algorithm is provided in FIG. 2.

III. Adding Sequences to the Custom Database

The generated custom database can be updated, manually or automatically, with sequences from GenBank or any other external database. Updating can be performed as frequently as desired by the researcher, however updating more frequently will result in a more complete database. For simplicity, only the GenBank database is referred to in the following description, though similar steps would be employed when utilizing other external databases. The generated custom database can be updated by the following steps: selecting desired taxonomic classifications from the Entrez Taxonomy database, retrieving GenBank sequences for the selected taxonomic classifications, and validating retrieved sequences against the criteria for the custom database. The custom database can be updated periodically. An automated computer program may also, as desired or periodically, either manually or automatically, be employed to identify and check sequences newly added to the GenBank database (e.g. monitoring entry and update dates). Additionally, a program may also be employed to avoid adding duplicate sequences to the custom database.

Each entry in the Taxonomy database is assigned a unique identifier (tax_id; which may also have several synonyms) and a single scientific name. Each Taxonomy entry also includes an identifier indicating its parent in the phylogenetic tree (parent_tax_id). Importantly, the Taxonomy database also contains a cross-reference to sequences in GenBank by gi_numbers.

Thus, the system may provide an interface to allow researchers to quickly scan the Taxonomy database's phylogenetic tree. The selected classifications are then associated with the custom database. An automated process may then use the Taxonomy database's cross-reference table to gather gi_numbers associated with the custom database based on the tax_id(s) selected. Each gi_number represents a candidate for the custom database. The sequence information for each gi_number is then retrieved from GenBank and subsequently passed through the selected validation conditions for the custom database. Validated sequences are entered into the custom database and those sequences that fail the validation process are discarded.

In another embodiment, the Taxonomy database's phylogenetic tree may be represented in a nested-set format to more readily identify parent-child relations in the phylogenetic tree (Mackey, A. Relational Modeling of Biological Data: Trees and Graphs. O'Rielly Bioinformatics Technology Conference, Nov. 27, 2002; Celko, J. SQL for Smarties: Advanced SQL Programming (2000) Morgan Kaufman Publishers). Specifically, instead of representing parent-child relationships explicitly, two pointers (left_id and right_id) are used to provide bounds for classification. In this representation, each child node's left_id and right_id must be between its parents left_id and right_id.

In addition to updating the system through searches of other databases, sequences obtained in the lab can be readily entered into the database. Certain methods for isolating nucleic acid molecules from biological sources are well known in the art, such as extracting genomic DNA from cultured isolates by the glass bead agitation method (Plikaytis, B. B., et al. (1990) J. Clin. Microbiol. 28:1913-1917) and subsequently purifying the crude DNA extract with the QIAmp Blood Kit (Qiagen Inc., Valencia, Calif.) according to protocols provided by the manufacturer. The regions of interest can be amplified through the use of specific primers and PCR or other suitable methods well known in the art. The isolated nucleic acids can then be sequenced, for example, by an automated system such as the ABI 377 automated sequencer (Applied Biosystems, Foster City, Calif.) or similar devices. The obtained sequences are then passed through the custom database's validation conditions. Validated sequence are subsequently entered into the custom database and those sequences that fail the validation process are discarded.

IV. Searching the Custom Database

After the custom database has been constructed, sequences may be searched against it. Such a search may include the following steps:

1) entering the unknown sequence information;

2) selecting custom database sequence regions to be searched;

3) validating the input sequence against the custom database validation conditions;

4) returning an error message if the input sequence fails the validation conditions;

5) computing similarity scores for each selected region against regions for each active sequence in the custom database if the input sequence is valid;

6) sorting the similarity scores from highest to lowest; and

7) outputting results and allowing researchers to view region alignments.

The similarity scores may be computed by a suitable algorithm. In a preferred embodiment, a modified version of the Similarity algorithm is employed (Setubal, J. And J. Meidanis. Introduction to Computational Molecular Biology. (1997) PWS Publishers). The modified version of the Similarity algorithm takes into account the possibility of wildcards or ambiguous nucleotides in either sequence. Wildcards are not counted as penalties in the scoring process.

The alignments to show where dissimilarities occur between an unknown sequence and a custom database sequence may also be performed by a suitable algorithm. For example, a modified version of the Align algorithm may be employed (Setubal, J. And J. Meidanis. supra). The modified Align algorithm returns a color-coded string to display the differences and takes into account wildcard characters in either the input string or the canonical database string. Additionally, spaces are not inserted where mismatches occur at wildcard characters.

V. Differentiation Between M. tuberculosis and M. bovis and Detection of Pyrazinamide Resistance

Provided in Example I are methods and compositions for the generation of a custom database (BioDatabase) which allows for the identification of almost any species of Mycobacterium. The provided BioDatabase application, however, does not allow for distinguishing between M. tuberculosis and M. bovis. Thus, in accordance with another aspect of the invention, methods and compositions for rapidly (i.e. less than 24 hours) and simultaneously identifying an unknown sample as M. tuberculosis or M. bovis in addition to the pyrazinamide resistance status of the isolate are provided.

Specifically, nucleic acid samples from an isolate are incubated with specific M. tuberculosis and M. bovis probes. These probes are typically generated by the PCR amplification of the pcnA region, including the promoter region, of reference M. tuberculosis and M. bovis isolates. In a preferred embodiment, the M. tuberculosis probe contains a single adenosine deletion at position (−42) to allow for the identification of all tested isolates.

The reference probes are mixed with isolated nucleic acids from the unknown sample, heated to a temperature which allows the nucleic acids to become single-stranded, and subsequently cooled to allow for the formation of heteroduplexes and homoduplexes. The products are then subjected to denaturing high performance liquid chromatography (DHPLC) to identify the various complexes formed (the elution was monitored for DNA by UV absorption at 260 nm). Alterations to the manufacturer's recommended DHPLC conditions allowed for maximizing the separation of the complexes formed. Specifically, the column temperature was raised to 65.8° C., the elution buffer slop was changed from 2% per minute to 1.2% per minute, and the run time was decreased to less than 10 minutes by increasing the start gradient for the elution buffer to 61%. The optimized conditions allowed for the proper identification of all tested isolates.

In yet another embodiment of the instant invention, the pncA region can be added to the BioDatabase of Example I to allow for the rapid differentiation of samples containing M. tuberculosis or M. bovis and the PZA resistance status of the isolate.

Further details regarding the practice of this invention are set forth in the following examples, which are provided for illustrative purposes only and is in no way intended to limit the invention.

### EXAMPLE I

### Identification of Mycobacterium Species by Generating and Employing a Custom Database

Introduction

The genus Mycobacterium comprises more than 70 species of acid-fast bacilli of which at least 30 different species have been associated with a wide variety of human and animal diseases (Shinnick, T. M. and R. C. Good (1994) Eur. J. Clin. Microbiol. Infect. Dis. 13: 884-901). Diseases caused by Mycobacterium are major contributors to morbidity and mortality throughout the world and their impact, specifically M. tuberculosis and M. avium, has increased with the rise of HIV (human immunodeficiency virus) infections (Bottger, E. C. (1994) Eur. J. Clin. Microbiol. Infect. Dis. 13:932-936; Butler, W. R., et al. (1993) Int. J. Syst. Bacteriol. 43:539-548; Plikaytis, B. B., et al. (1992) J. of Clin. Microbiol. 30:1815-1822). The World Health Organization (WHO) estimates that 3.3 million people died from M. tuberculosis in 1995 and that over a billion people will be infected with Mycobacterium over the next 20 years of which 200 million will develop symptoms and 35 million will die.

In humans, three main groups of Mycobacterium are responsible for the majority of diseases: M. tuberculosis complex, M. avium complex (MAC), and non-tuberculosis Mycobacterium (NTM). The M. tuberculosis complex consists largely of M. tuberculosis and M. bovis. The M. avium complex consists of infections by M. avium which are most common among AIDS patients. Similarly, non-tuberculosis Mycobacterium infections are more common among immunocompromised patients, but result in skin lesions, pulmonary diseases, and internal organ lesions.

The rapid identification of Mycobacterium to the species level is of significant importance for several reasons. One such reason is that Mycobacterium species identification would allow for greater surveillance of infections to identify the incident source and establish control programs. More importantly, rapid species identification would allow for better treatment of patients as certain drugs are effective only against specific strains (Springer, B., et al. (1996) J. Clin. Microbiol. 34:296-303).

The identification of Mycobacterium by conventional methods is a slow and tedious laboratory procedure which typically requires several weeks for adequate growth of the isolate and eventual identification by performing a series of biochemical tests. Notably, accurate identification is not always possible by the conventional methods due to such factors as inadequate growth, contamination, and phenotypic variability (Springer, B. supra; Devallosis, A., et al. (1997) J. Clin. Microbiol. 35:2969-2973).

Another widely employed assay is a DNA probe assay (e.g., Accuprobe® system, Gen-Probe, San Diego, Calif.). This assay, however, is limited in that it requires a one week culture period, it can not be used directly on clinical specimens, and it can only distinguish among the M. tuberculosis complex, MAC, M. kansaii, and M. gordonae. Notably, the method of the instant invention can be performed within 24 hours of obtaining an isolate as PCR can be performed directly on patient specimens such as bronchial wash fluid (Telenti, A., et al. (1993) Lancet. 341:647-650). Additionally, the instant invention may distinguish between the following group of Mycobacterium species, without limitation: M. abscessus, M. acapulcensis, M. africanum, M. asiaticum, M. avium, M. avium-intercellularae, M. avium complex, M. bohemicum, M. bovis, M. celatum, M. chelonae, M. fortimtum, M. fortuitum sequevar Mfo-C, M. gallinarum, M. genavanse, M. M. gilvum, M. gordonae, M. gordonae-A, M. gordonae-B, M. habana, M. holsaticum, M. intercellularae Min-A, M. intercellularae Min-B, M. intercellularae Min-C, M. intercellularae Min-D, M. kansaii, M. paratuberculosis, M. porcinum, M. scrofulaceum, M. senegalese, M. shemoidei, M. simiae Msi-C, M. simiae Msi-D, M. szulgai-A, M. szulgai-B, M. triplex, M. tuberculosis, M. tuberculosis complex, M. ulcerans, M. vaccae, and M. xenopi.

The sequencing of genetic elements in Mycobacterium allows for the rapid and accurate identification of certain species of Mycobacterium. At least three different genes have been reported as useful targets for sequencing to identify the species of Mycobacterium including: the 16S ribosomal RNA (rRNA) gene, hsp65 gene, and recA gene (Blackwood, K. S., et al. (2000) J. Clin. Microbiol. 38:2846-2852; Ringuet, H., et al. (1999) J. Clin. Microbiol. 37:852-857). Of these genes, the 16S rRNA gene has been employed the most and a commercially available database (MicroSeq® 500 16S rDNA Bacterial Identification System, Applied Biosystems, Foster City, Calif.) has been produced (Rogall, T., et al. (1990) Int. J. Syst. Bacteriol. 40:323-330; Van Der Vliet, G. M., et al. (1993) J. Gen. Microbiol. 139:2423-2429; Kempsell, K. E., et al. (1992) J. Gen. Microbiol. 138:1717-1727; Cloud, J. L., et al. (2002) J. Clin. Microbiol. 40:400-406). The utilization of the 16S rRNA gene has a significant limitation, however, in that it can only distinguish among a limited set of species because the 16S rRNA gene is highly conserved in Mycobacterium (Rogall, T. supra; Dobner, P., et al. (1996) J. Clin. Microbiol. 34:866-869). For example, the 16S rRNA gene analysis can not differentiate between M. abscessus, M. chelonae, and M. fuerth; M. gastri and M. kansasii; M. farcinogenes and M. senegalense; and M. peregrinum and M. septicum. The ribosome internal transcribed spacer (ITS) regions within the rRNA genes have recently been reported as possible genetic elements that can provide for Mycobacterium identification because of their greater variability between genuses and strains (Frothingham, R. and K. H. Wilson (1994) J. Infect. Dis. 169:305-312; (Frothingham, R. and K. H. Wilson (1993) J. Bacteriol. 175:2818-2825; Ross, B. C., et al. (1992) J. Clin. Microbiol. 30:2930-2933; De Smet, K. A., et al. (1995) Microbiol. 141:2739-2747; Frothingham, R., et al. (1994) J. Clin. Microbiol. 32:1639-1643).

Custom Database Generation

The custom database (BioDatabase) generated for Mycobacterium species identification includes two regions, a 16S rRNA gene region and an ITS region. The 16S rRNA gene region was defined by the start sequence GTCGAACGG (SEQ ID NO: 1) and the ending sequence GGCCAACTACGT (SEQ ID NO: 2). The ITS region (located between the 16S and 23S genes of the ribosomal gene cluster) was defined by the start sequence CACCTCCTTTCT (SEQ ID NO: 3) and the end sequence GGGGTGTGG (SEQ ID NO: 4). Both regions contained identical preferences. The wildcard for both regions was ‘N’. The threshold for wildcards was zero for sequences to be entered into the database and two for sequences to be searched against the database. The character-run limit was set to 6. Sequences for the custom database were obtained both in the lab and from GenBank, validated, and subsequently entered into BioDatabase.

Sequences were obtained in the lab by the following method. Pan-Mycobacterium ITS sequence primers, 5′-GAAGTCGTAACAAGGTAGCCG-3′ (SEQ ID NO: 5) and 5′-GATGCTCGCAACCACTATCCA-3′ (SEQ ID NO: 6), were used to amplify the genetic elements of interest only from members of the genus Mycobacterium. The primers 5′-TGGCTCAGGACGAACGCTGG-3′ (SEQ ID NO: 7) and 5′-ACAACGCTCGCACCCTACG-3′ (SEQ ID NO: 8) were employed to amplify the Mycobacterium 16S rRNA gene region. The sequence of the obtained PCR products was determined using automated instrumentation. The sequences were validated prior to entry into the database.

Results

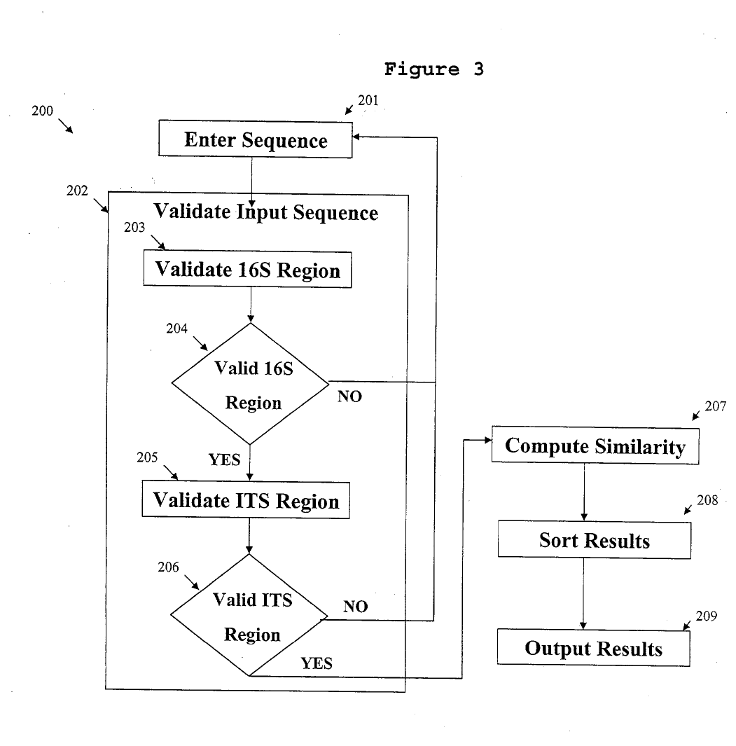

Searches over both the 16S rRNA gene and ITS regions of the custom database were preformed with a sample set of 78 specimens, including reference cultures and clinical isolates, that were previously identified using various laboratory techniques. FIG. 3 shows the flow control (200) of the BioDatabase application in the instant case study. Briefly, a sequence is obtained and entered into the application (201). The sequence is checked against the selected validation conditions of the database (202). Specifically, the entered sequence may be checked against the validation conditions set forth for the 16S region (203). If the sequence is not valid (204), the sequence is discarded and a new sequence can be entered (201). If the original sequence is valid (204), the sequence is then checked against selected validation conditions for the ITS region (205). If the sequence is not valid (206), the sequence is discarded and a new sequence can be entered (201). If the sequence is valid (206), the sequence is then checked against the custom database and the similarity is computed (207). The results from the similarity comparison is then sorted (208) and outputted (209).

The results from the searches of the sample set demonstrate the ability of the BioDatabase application to accurately identify members of the genus Mycobacterium not only to the species level, but also to the strain level. Specifically, of the 78 previously identified isolates, 72 were correctly identified using BioDatabase. The remaining 6 sequences failed to match with any of the sequences within the database. Inasmuch as the ITS sequence database is sensitive enough to distinguish between not only different species but also different strains, the 6 unmatched sequences may represent new strains. This possibility can be confirmed by additional clinical testing. The ability to correctly identify all samples that were present within the database confirms the use of the ITS region as an identification marker for Mycobacterium species and strains.

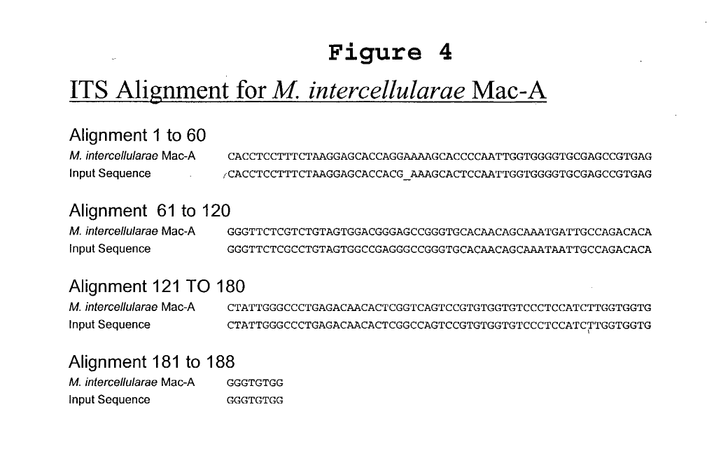

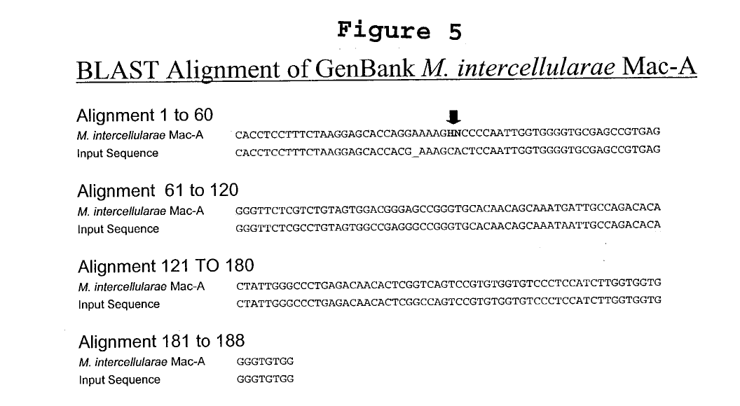

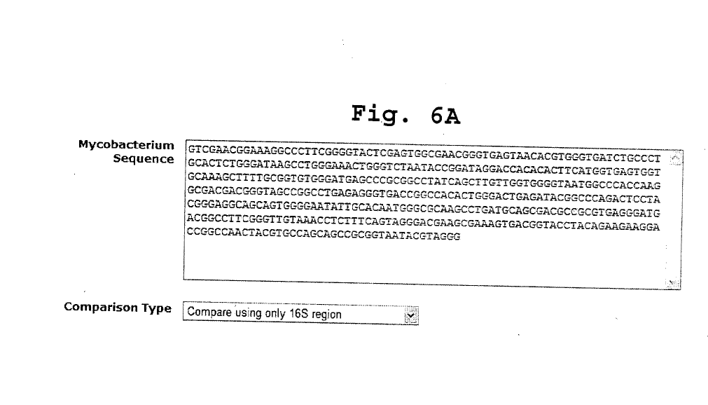

FIGS. 4 and 5 exemplify the superiority of the BioDatabase application over the GenBank dependent BLAST search in correctly identifying Mycobacterium species. Using the BioDatabase, the closest match to a tested unknown sequence was identified as M. intercellularae strain Mac-A (FIG. 4). This result was confirmed by conventional biochemical tests. In contrast, a BLAST search of the test sequence against the GenBank database resulted in the identification of the sequence as from M. malmoense. The discrepancy was due to the presence of ambiguous bases (H,N) in the GenBank sequence (see FIG. 5). This example not only illustrates the inherent problems with the amount and quality of data in GenBank, but also the pitfalls of heuristics in general such as BLAST.

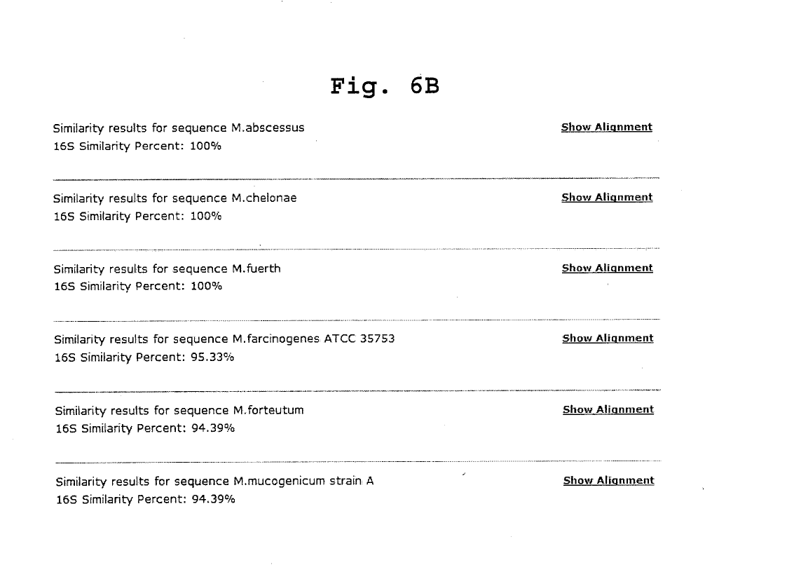

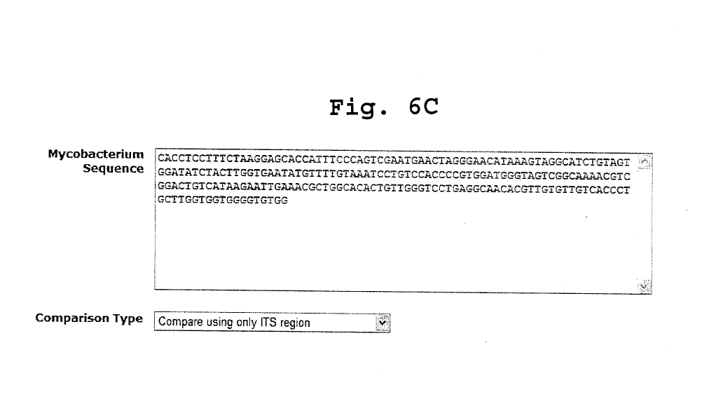

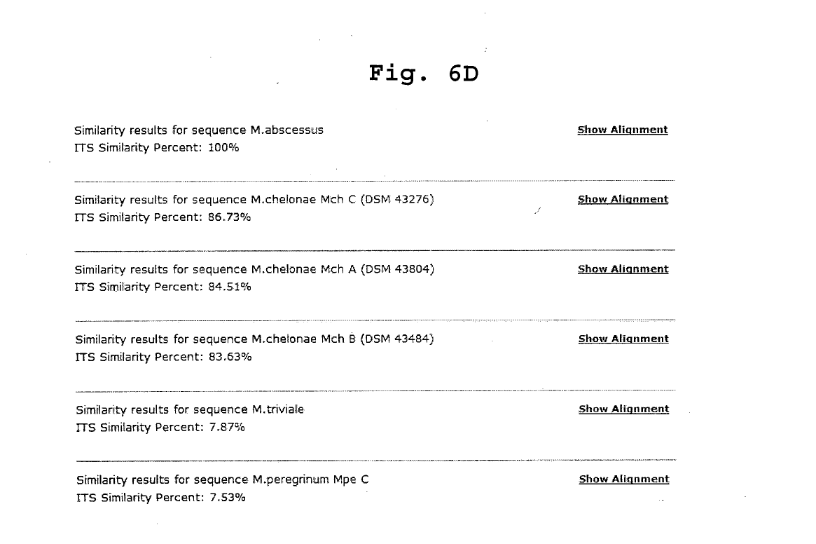

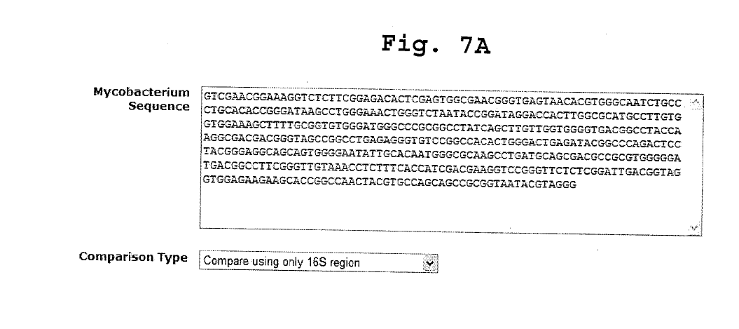

The following examples demonstrate the superiority of employing a database consisting of sequences from the ITS region over a database consisting of sequences from the 16S rRNA gene region. A set of sequences from an unknown sample was entered into the BioDatabase application (FIGS. 6A and 6C). Upon searching with just the 16S rRNA gene region, three species were identified as 100% matches: M. abscessus, M. chelonae, and M. fuerth (FIG. 6B). In contrast, searching of the ITS sequences correctly identified only a single species that was a 100% match for the unknown sequence, M. abscessus (FIG. 6D).

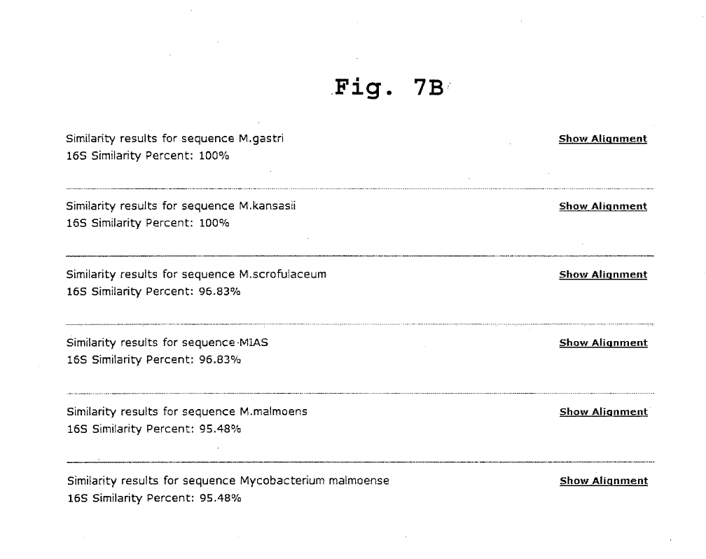

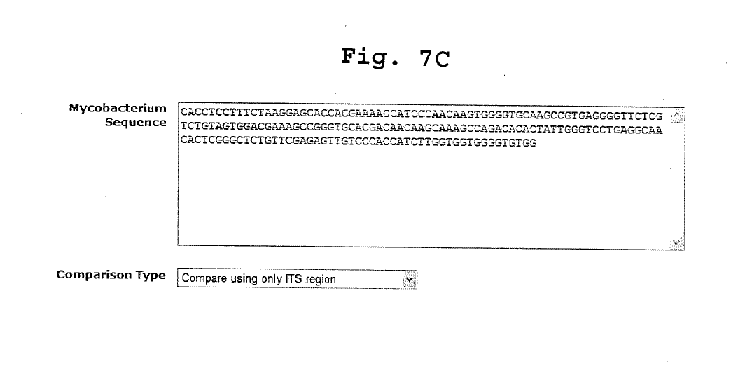

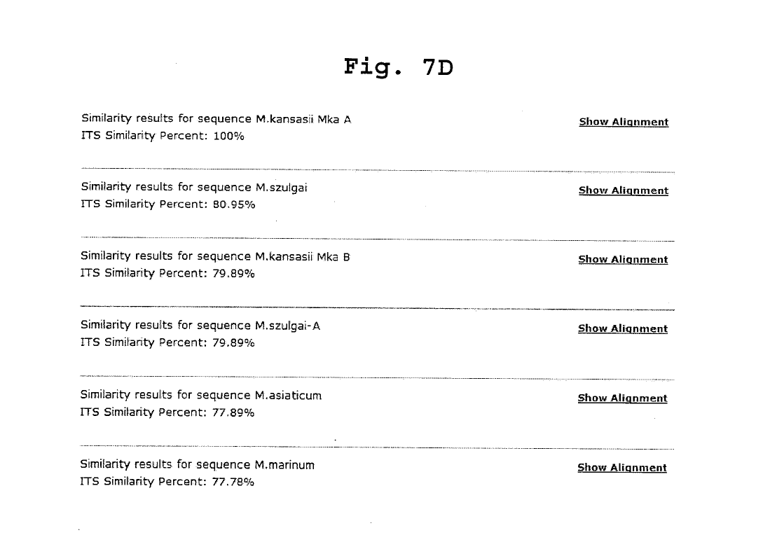

A second set of sequences from another unknown sample was entered into the BioDatabase application (FIGS. 7A and 7C). When searched only against the 16S rRNA gene region, the application was unable to determine if the sample was M. gastri or M. kansasii (FIG. 7B). Searching against the ITS region sequences, however, led to the correct identification of the unknown sample as the Mka A strain of M. kansasii (FIG. 7D).

### EXAMPLE II

### Method of Identifying Pyrazinamide Drug Resistance

Introduction

Despite the high variability of the ITS sequence within Mycobacterium, comparison of the ITS region alone will not allow for the differentiation between M. tuberculosis and M. bovis of the MTC. Notably, M. tuberculosis and M. bovis are the most important causative agents of tuberculosis in man and animal. Rapidly distinguishing between these two species is important because almost all strains of M. bovis are naturally resistant to pyrazinamide (PZA), but M. tuberculosis resistance to PZA is rare (Scorpio, A. and Y. Zhang (1996) Nat. Med. 2:662-667; Konno, K., et al. (1967) Am. Rev. Respir. Dis. 95:461-469). PZA is a common first line drug against tuberculosis (Bass, J. B., Jr., et al. (1994) Am. J. Respir. Crit. Care Med. 149:1359-1374). In combination with isoniazid, rifampin, and ethambutol, PZA shortens the treatment period from 18 months to 6 months (Balasubramanian, R., et al. (1997) Int. J. Tuberc. Lung Dis. 1:44-51; Sanchez-Albisua, I., et al. (1997) Pediatr. Infect. Dis. J. 16:760-763). PZA is a prodrug which is converted into its active form, pyrazinoic acid, by the enzyme Pzase (Speirs, R. J., et al. (1995) Antimicrob. Agents Chemother. 39:1269-1271). The correlation between PZA resistance and Pzase activity is supported by the demonstration of a quantitative loss of this activity in resistant isolates (Miller, M. A., et al. (1995) J. Clin. Microbiol. 33:2468-2470; Trivedi, S. S. and S. G. Desai. (1987) Tubercle. 68:221-224).

The genetic basis for PZA-resistance involves mutation within the pncA gene which encodes for Pzase (Morlock, G. P., et al. (2000) Antimicrob. Agents Chemother. 44:2291-2295; Scorpio, A. and Y. Zhang. supra). Although, cases of PZA-resistant M. tuberculosis isolates with no pncA mutations have been reported, mutations of pncA and its putative promoter remain the major mechanism of PZA resistance (Lemaitre, N., et al. (1999) Antimicrob. Agents Chemother. 43:1761-1763; Morlock, G. P. et al. supra). Over 40 different mutations associated with PZA resistance in M. tuberculosis have been described in either the pncA structural gene or its putative promoter. The changes are either mutations that involve substitution of nucleotides or mutations in the form of nucleotide insertions or deletions (Lemaitre, N. et al. supra; Morlock, G. P. et al. supra; Scorpio, A., et al. (1997) Antimicrob. Agents Chemother. 41:540-543). In contrast, the natural resistance to PZA demonstrated by M.bovis strains is uniformly due to a unique single point mutation (C₁₆₉G) in pncA. This mutation involves substitution of histidine (CAC) with aspartic acid (GAC) leading to the production of inactive enzyme (Scorpio, A., et al. (1997) J. Clin. Microbiol. 35:106-110; Scorpio, A. and Y. Zhang. supra).

Susceptibility testing to detect PZA resistance has recently received increased attention for a number of reasons. These include: 1) the important role of PZA in shortening the time course for treatment of tuberculosis as indicated above, 2) the recent recognition of PZA-monoresistant strains of M.tuberculosis (Hannan, M. M., et al. (2001) J. Clin. Microbiol. 39:647-650), 3) the increasing frequency of tuberculous infections following intravesical instillation of the naturally PZA-resistant M.bovis BCG strain for the treatment of superficial bladder cancer (Aljada, I. S., et al. (1999) J. Clin. Microbiol. 37:2106-2108; McParland, C., et al. (1992) Am. Rev. Respir. Dis. 146:1330-1333; Morgan, M. B. and M. D. Iseman. (1996) Am. J. Med. 100:372-373), and 4) the increasing incidence of zoonotic tuberculosis in developing countries due to PZA-naturally resistant M.bovis (Cosivi, O., et al. (1998) Emerg. Infect. Dis. 4:59-70; Long, R., et al. (1999) Am. J. Respir. Crit. Care Med. 159:2014-2017; Robles Ruiz, P., et al. (2002) Clin. Infect. Dis. 35:212-213).

Conventional mycobacterial susceptibility testing for PZA is dependent on growth of the organism in the presence of the drug. This technique is both time consuming (up to 4 weeks) and potentially unreliable due to the poor growth of M.tuberculosis in the highly acidic medium required for PZA activity (Davies, A. P., et al. (2000) J. Clin. Microbiol. 38:3686-3688; Hewlett, D., Jr., et al. (1995) JAMA. 273:916-917). Automated testing systems, such as the BACTEC™ 460TB and BACTEC™ MGIT 960 (Becton Dickinson, Franklin Lakes, N.J.), are more sensitive than conventional testing. These automated testing systems, however, require from 8 to 12 days to determine antibacterial susceptibility and have the potential for cross-contamination (Hewlett, D., Jr., et al. supra; Leitritz, L., et al. (2001) J. Clin. Microbiol. 39:3764-3767; Tortoli, E., et al. (2002) J. Clin. Microbiol. 40:607-610).

Genotypic assays that rely on detection of mutations associated with drug resistance have been applied to both cultured isolates and direct patient specimens. These include amplification techniques, DNA sequence analysis, PCR-single-strand conformation polymorphism electrophoresis (PCR-SSCP), structure-specific cleavage and DNA probe detection assays, all of which are capable of detecting mutations associated with drug resistance (Gingeras, T. R., et al. (1998) Genome Res. 8:435-448; Piatek, A. S., et al. (1998) Nat. Biotechnol. 16:359-363; Telenti, A., et al. (1993) Lancet. 341:647-650).

Temperature mediated heteroduplex analysis (TMHA) using denaturing high performance liquid chromatography (DHPLC) has been applied to the detection of specific gene polymorphisms (Narayanaswami, G. and P. D. Taylor (2001) Genet. Test. 5:9-16). This technology has been recently applied to the detection of mutations associated with anti-tuberculous drug resistance (Cooksey, R. C., et al. (2002) J. Clin. Microbiol. 40:1610-1616). The technique utilized differential retention of homoduplex and heteroduplex DNAs under partial denaturing conditions for the identification of mutations in rpoB, katG, rspL, embB and pncA that are responsible for rifampin, isoniazid, streptomycin, ethambutol and pyrazinamide resistance, respectively. Additionally, a separate genetic element (oxyR) was utilized to differentiate between M. tuberculosis and M. bovis. Although the study demonstrated the feasibility of this approach for detecting drug resistance for multiple antimicrobial agents, detection of mutations in pncA were found to be problematic. The difficulty of detecting pncA mutations was attributed to the diverse nature of the mutations and the distribution of the mutations throughout the gene and its putative promoter. The potential for highly stable DNA helices due to increased GC content within specific regions of the pncA gene has been proposed as a major technical challenge for TMHA methodology (Cooksey, R. C., et al., supra).

To overcome these difficulties, the experimental conditions of the TMHA assay were reengineered and a two probes were employed including a mutant form. In combination, these changes provided for the rapid identification of pncA mutations associated with PZA resistance and the ability to distinguish between the two closely related species of the MTC, M. bovis and M. tuberculosis, using the same genetic target.

Materials and Methods

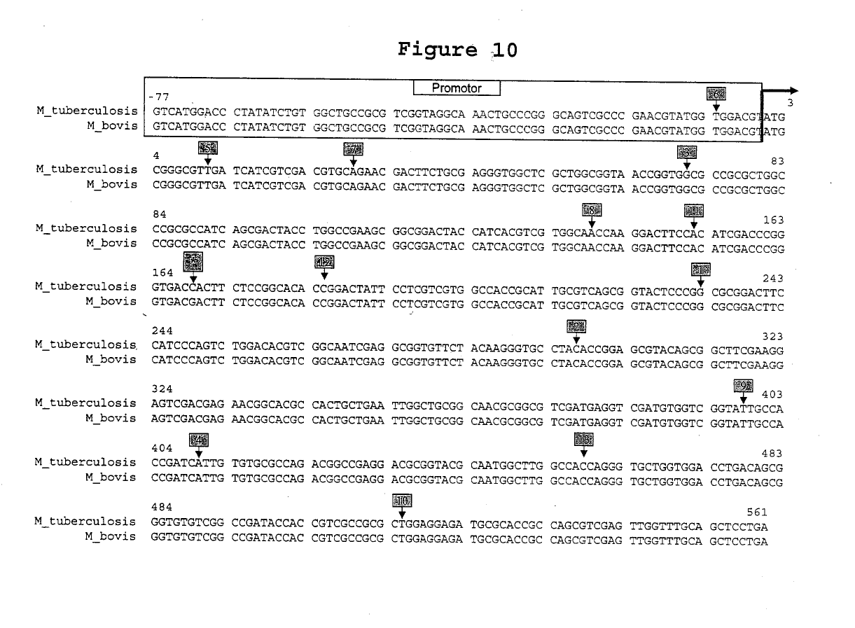

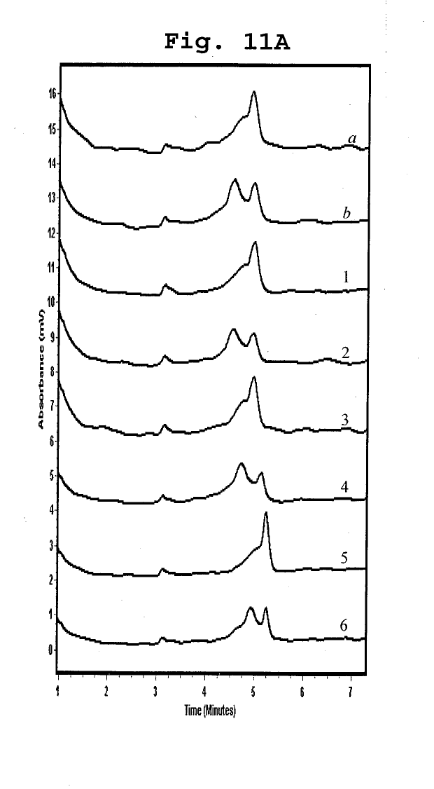

Sixty-nine isolates of the MTC were studied including 48 M. tuberculosis strains of which 13 were PZA-resistant, and 21 M. bovis strains of which 8 were BCG strains. The PZA resistant M. tuberculosis isolates were obtained from either the Tuberculosis Diagnostic Laboratory of the Centers for Disease Control and Prevention (CDC) or the Tuberculosis Diagnostic Section of the Michigan Public Health Laboratory (Morlock, G. P., et al. supra). The pncA gene from each of the 13 PZA resistant M. tuberculosis strains had previously been sequenced and found to contain different mutations distributed throughout pncA ORF as well as the promoter region (FIG. 10). The study isolates included six reference M.bovis BCG strains (catalog No. 35743 American Type Culture Collection (ATCC), Manassas, Va.; ATCC 35744; ATCC 35739; ATCC 35731; ATCC 35738; and ATCC 35748) from the CDC collection. Fifty clinical isolates were obtained from either Creighton University Medical Center (5 M.tuberculosis and 5 M.bovis); CDC, (4 M.bovis isolates) or University of Nebraska Medical Center (UNMC), (4 M.bovis, 2 M.bovis BCG and 30 M.tuberculosis). PZA susceptibility was previously determined for all isolates, with resistance defined by a minimum inhibitory concentration (MIC) greater than 25 μg/ml using the proportion method with Middlebrook 7H10 medium (Canetti, G., et al. (1969) Bull. World Health Organ. 41:21-43). Two reference strains were used as probes in the TMHA study: M.tuberculosis H37Rv, obtained from UNMC and M.bovis ATCC 19210, obtained from the CDC. Amplicons for use as probes in the assay were generated from these reference strains using the primers described below. To determine the analytic specificity and cross-reactivity of our assay, six additional reference strains of non tuberculous Mycobacterium species were included; M.avium (ATCC 25291), M.intracellulare (ATCC 13950), M.fortuitum (ATCC 6841), M.chelonae (ATCC 35751), M.kansasii (ATCC 35775), and M.gordonae (ATCC 14470).

Genomic DNA was extracted from cultured isolates by the glass bead agitation method as previously described (Plikaytis, B. B., et al. (1990) J. Clin. Microbiol. 28:1913-1917). The crude DNA extract was purified using the QIAmp Blood Kit (Qiagen Inc., Valencia, Calif.) according to protocols provided by the manufacturer.

Specific primers were designed using Oligo™ Version 6.4 software (Molecular Biology Insight, Inc., Cascade, Colo.) to generate a 638 base pair (bp) amplicon that includes the entire pncA gene and its putative promoter. The sequence of the forward primer, AW-A3 (5′-GTCATGGACCCTATATCTGTGGCTGCCGCGTCG-3′; SEQ ID NO: 9), began at bp −77 upstream of the open reading frame (ORF) and that of the reverse primer, AW-A6 (5′-TCAGGAGCTGCAAACCAACTCGACGCTGG-3′; SEQ ID NO: 10), began at the stop codon (bp 561). The second primer set is used for generating the second mutated M. tuberculosis probe (the sequence of the forward primer, AW-A33 (5′-GTCATGGACCCTATATCTGTGGCTGCCGCGTCGGTGG-3′; SEQ ID NO: 11), began at bp −77 upstream of the ORF with a deletion of adenine at position −42 (Δ42). The reverse primer is the same as the first set (AW-A6).

The PCR assay was performed using 5 μl template DNA (10 ng/μl) in a total reaction volume of 50 μl to include PCR buffer 20 mM Tris-HCL (pH 8.4), 50 mM KCl; 0.1 mM (each) DATP, dGTP, dTTP, and dCTP; 1.5 mM MgCl₂; 0.3 μM (each) primer and 1.5 U of PlatinumTaq High-Fidelity DNA polymerase (Gibco BRL, Life Technologies, Gaithersburg, Md.). Amplification was performed on a Stratagene Robocycler model 96 thermocycler (Stratgene, LaJolla, Calif.), starting with an initial denaturation step at 95° C. for 10 min., followed by 35 cycles with each cycle consisting of a denaturation step at 95° C. for 1 min., an annealing step at 64° C. for 1 min. and an extension step at 72° C. for 1 min. An additional extension step at 72° C. for 7 min. was performed after the last cycle. Amplicons were stored at 4° C. until used.

PCR products from selected PZA resistant M.tuberculosis isolates were cloned directly following amplification using the standard protocol of the Original TA Cloning kit (Invitrogen, San Diego, Calif.). Purified plasmids from selected colonies were screened for the correct insert by digestion with endonuclease EcoRI (New England Biolabs, Beverly, Mass.) and analyzed by gel electrophoresis for the presence of an approximate 600 bp product. Selected plasmids were sequenced at the Epply Molecular Biology Core Laboratory (UNMC, Omaha, Nebr.) using the universal M13 forward and reverse sequencing primers. Sequences were analyzed for the presence of mutations of interest by alignment against wild type M.tuberculosis sequence using the MacVector sequence analysis software Version 6.5 (Oxford Molecular group, Inc., Campbell, Calif.).

The TMHA assay was performed using the commercially available WAVE™-DHPLC System (Transgenomic inc. Omaha, Nebr.). Since the hydrophobic matrix (polystyrene-divinylbenzene copolymer beads) of the WAVE-DNASep® cartridge is electrostatically neutral and it does not readily react with DNA, an ion-pairing reagent, triethylammonium acetate (buffer A) was used to adsorb DNA to the cartridge according to the manufacturer's protocol. An elution buffer composed of 0.1M triethylammonium acetate in 25% acetonitrile (buffer B) was used to elute DNA based on size and/or sequence composition. Once eluted, the DNA was detected spectrophotometrically by UV absorption at 260 nm. The DNA molecules were analyzed for integrity using non-denaturing conditions at a column temperature of 50° C. For mutation detection, partially denaturing conditions were used at a column temperature range of 52° C. to 70° C. (Narayanaswami, G. and P. D. Taylor (2001) Genet. Test. 5:9-16).

PCR products of all isolates were analyzed for purity, specificity, and DNA concentration using the universal DNA sizing gradient concentration program and a column temperature of 50° C. with DHPLC. The PhiX174 DNA ladder was used as the sizing marker. The sizing capability of the WAVE™ system provided for analysis of purity and only those amplicons shown to generate a single uniform peak of the correct size were used for subsequent analysis.

DNAs from reference strains M.tuberculosis H37Rv (ATCC 25618) and M.bovis (ATCC 19210) were used for individual hybridization with each of the test isolates. In a total volume of 50 μl, equimolar ratios of test and reference DNA molecules were mixed together in the presence of polymerization inactivation buffer (5.0 mM EDTA, 60.0 mM NaCl, and 10.0 mM Tris, pH 8.0). The mixture was heated to 95° C. for 4 min. and then left at room temperature for gradual cooling to 35° C. over 45 min. For heteroduplex analysis, both homoduplex and heteroduplex molecules were generated by hybridization of the PCR product for each of the tested isolates with each of the reference DNA probes.

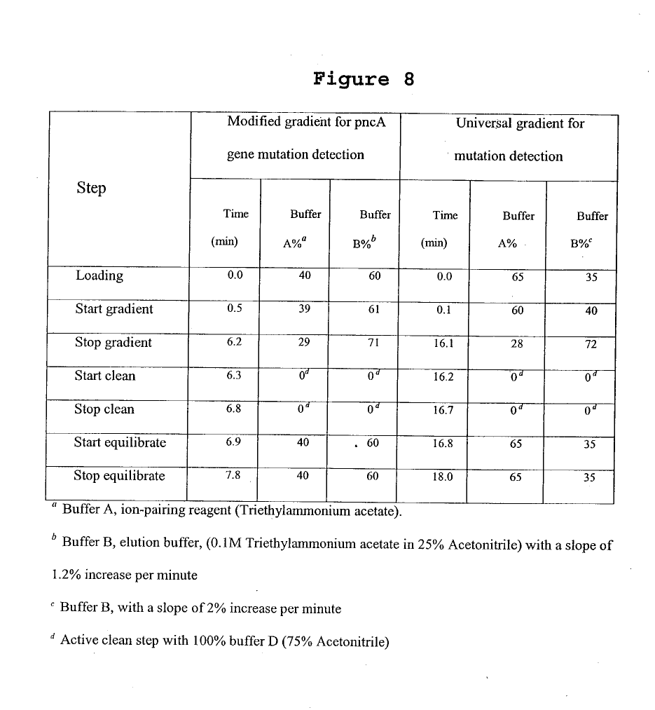

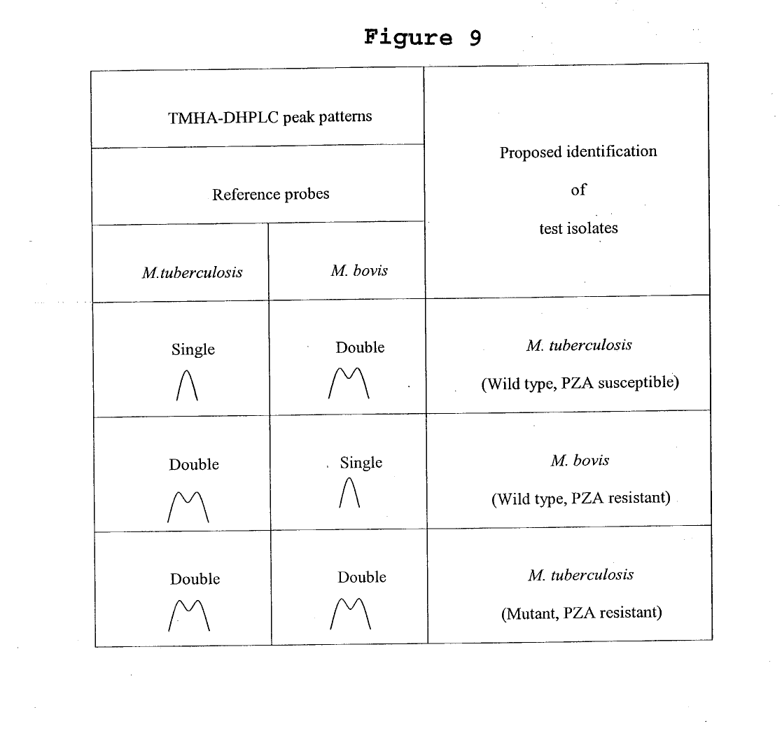

Following hybridization, mixtures of test isolates and reference probes were analyzed for pncA mutations using the partially denatured mode of the DHPLC. A variety of gradient concentrations were examined with different starting concentration of buffer B at different rates of increase (slope), and a range of column temperatures from 64.8° C. to 66.8° C. was evaluated. A modified gradient concentration program (FIG. 8) and a column temperature of 65.8° C. were chosen for all subsequent mutation detection studies. A set of three mixtures of wild type reference DNAs (both M. tuberculosis and M. bovis) and reference probes were included with each run of the test isolates. Each of the test isolates was analyzed at least three times on three successive days using 3 different PCR products from each template to test the reproducibility of the chromatographic patterns. Chromatographic patterns of test isolates were compared with those of reference isolates and interpretations were made according to the proposed protocol (FIG. 9). Accordingly, any test isolate which generated a single peak pattern with the M. tuberculosis reference probe and a double peak pattern with the M. bovis reference probe was identified as wild type M. tuberculosis, whereas any test isolate which generated a double peak pattern with the M. tuberculosis reference probe and a single peak pattern with the M. bovis reference probe was identified as M. bovis or strain BCG. Isolates that produced a double peak pattern with both reference probes were identified as mutant strains of M. tuberculosis (PZA resistant). A double peak pattern was defined as a negative deflection following a peak that created a visible trough between adjacent peaks. For each of the double peaked chromatographic patterns, the distance between the peaks was recorded.

Results

The specificity, purity and concentration of PCR products from PZA-resistant mutant M.tuberculosis, wild type M.tuberculosis, wild type M.bovis, and M.bovis BCG were determined using the non-denaturing mode of the DHPLC system at a column temperature of 50° C. All tested isolates generated uniform products with an identical relative retention time and approximate size of 600 bp as compared to the PhiX 174 DNA ladder. Analytic specificity of the assay was demonstrated through testing of DNA from six different reference species of nontuberculous mycobacteria which generated either variable small peaks consistent with nonspecific products or no product.

Following optimization of the system, duplexes formed between PCR products of the tested isolates and each of the two reference probes were analyzed using the partially-denatured mode of the system at the optimal buffer concentration gradient (FIG. 8) and column temperature of 65.8° C.

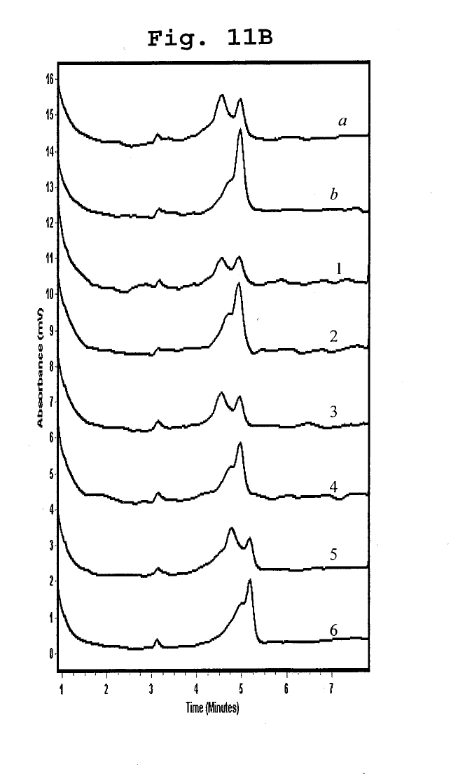

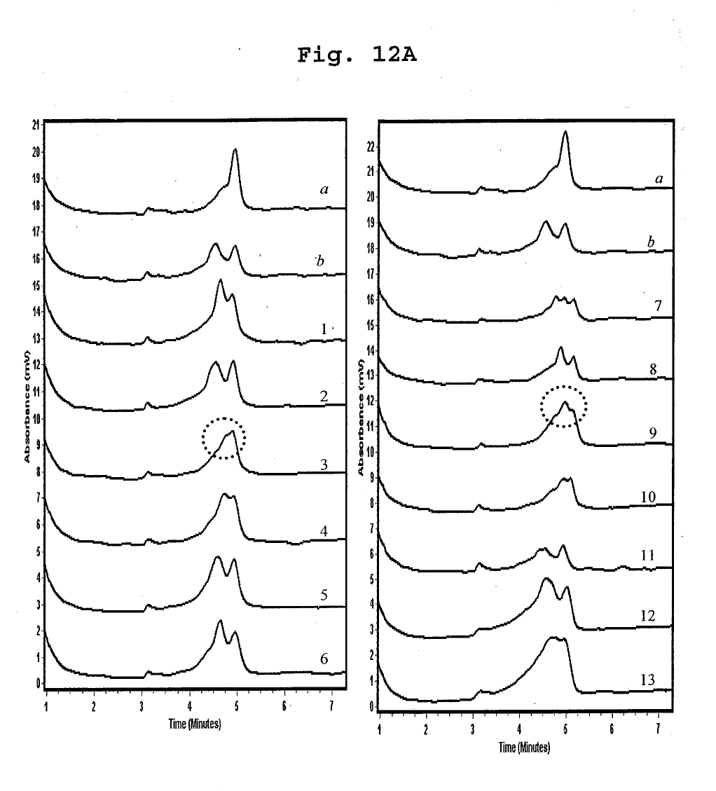

Chromatographic patterns produced by the wild type PZA susceptible isolates of M. tuberculosis demonstrated single peak patterns when mixed with the M. tuberculosis reference probe (SEQ ID NO: 19) and double peak patterns when mixed with the M. bovis reference probe (SEQ ID NO: 20) as predicted (FIG. 11A). In contrast, M. bovis isolates produced double peak patterns when mixed with the M.tuberculosis reference probe and single peak patterns when mixed with the M.bovis reference probe (FIG. 11B).

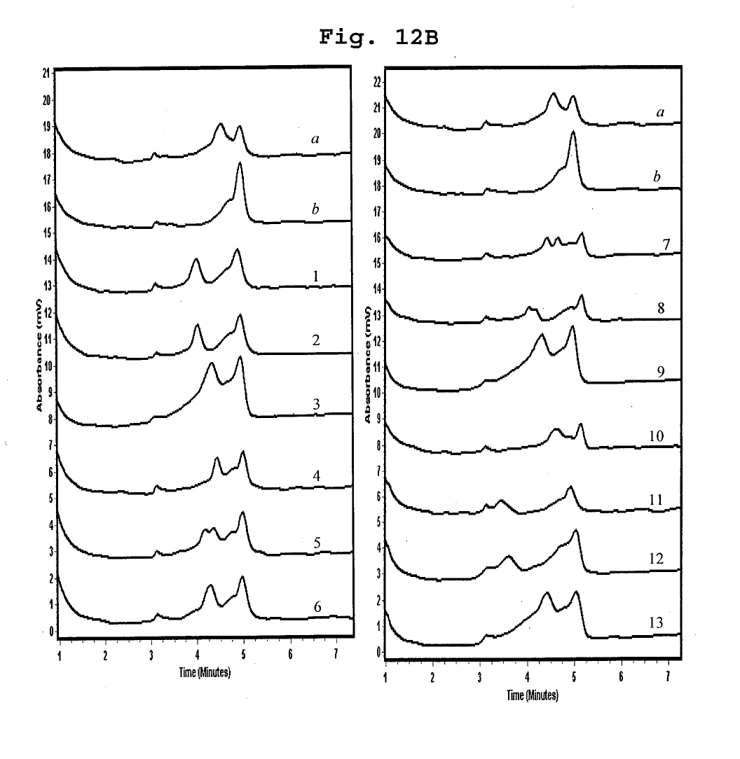

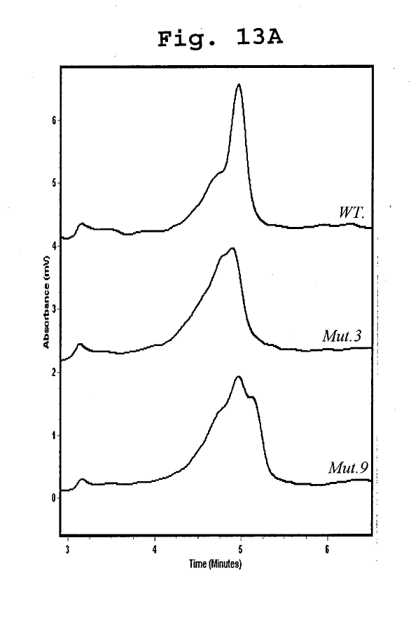

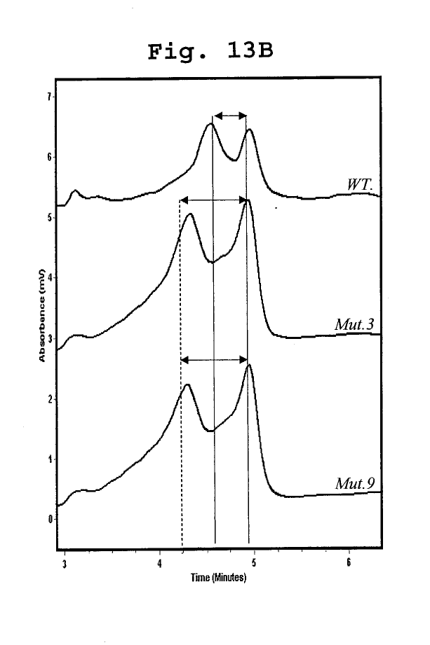

TMHA of the PZA-resistant, pncA mutant M.tuberculosis strains generated the predicted chromatographic patterns with two peaks or more in 11 of the 13 isolates tested with both reference probes (FIGS. 12A and B) . For two of the mutant isolates (mutant 3 and mutant 9), non-standard but reproducible chromatographic patterns were produced when mixed with the M.tuberculosis reference probe (FIGS. 12A and B, circled patterns). Further investigation showed that these chromatographic, patterns contained distinct features that provided for their consistent recognition. In comparison with the single sharp peak generated by the wild type PZA susceptible M. tuberculosis isolates when mixed with the M. tuberculosis reference probe, mutant 3 produced a broad peak with a shoulder on one side, while mutant 9 produced double shouldered peak (FIG. 13A). When mixed with M.bovis reference probe, both mutant 3 and 9 generated the predicted double peak patterns characteristic of all other mutant isolates. However, in comparison with chromatographic patterns generated by wild type isolates, the mutant isolates demonstrated earlier elution of the first peak (heteroduplex DNA) relative to that of the second peak (homoduplex DNA). This resulted in greater separation between the double peaks generated by the mutant isolates when compared to those generated by the wild type isolates (FIG. 13B). When all of these observations were combined in the analysis, a protocol was developed that provided for the identification of all mutant isolates as distinct from wild type M. tuberculosis isolates. Further, since the chromatographic patterns were distinct for all M. bovis isolates, it was possible to distinguish them from either mutant or wild type M. tuberculosis isolates.

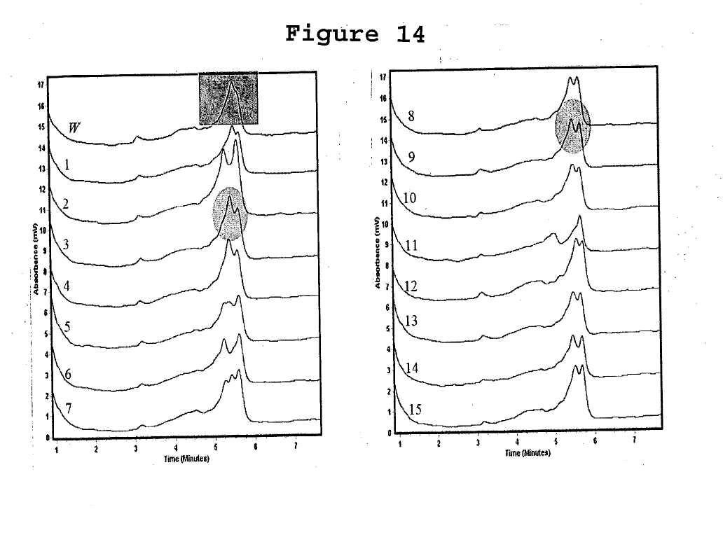

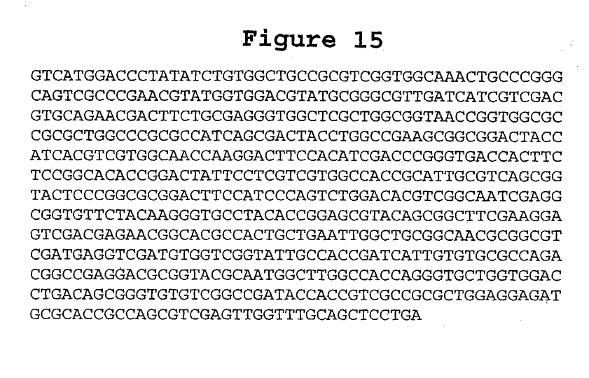

In order to increase the sensitivity for detection of mutations within problematic regions including those sequences having a high GC content (helical fraction higher than 75%) and those having a very low GC content (helical fraction less than 50%), mutations were made throughout the pncA region. These mutations included ΔA₋₄₂, A₋₄₂G, A₋₄₂C, ΔT₋₄₇, T₋₄₇G, T₋₄₇C, ΔG₁₆₅, G₁₆₅A, G₁₆₅T, ΔG₁₄₅, G₁₄₅A, G₁₄₅T, ΔT₅₃₉, T₅₃₉G, and T₅₃₉C. Probes comprising the aforementioned mutations were tested for their ability to differentiate between M. tuberculosis and M. bovis. Only the M. tuberculosis probes containing the ΔA₋₄₂ mutation (generated by using the AW-A33 and AW-A6 primers; SEQ ID NO: 21) allowed for the detection of all different types of pncA mutations (FIG. 14). The mutation within the probe in combination with the mutation of the test isolate allowed for the detection of all types of mutations including those that were difficult to identify using the “wild-type” probe (e.g. mutants 3 and 9; compare FIG. 12 and FIG. 14). Notably, when the mutant probe was used with wild-type strains, it still produced only a single peak pattern (FIG. 14).

Discussion

The polymorphism within M.bovis strains is unique and different from all of the known acquired mutations of pncA of PZA resistant M.tuberculosis. Therefore, a second probe was generated from the M.bovis pncA gene for use in combination with the wild type M.tuberculosis probe. Differentiation between wild type M.tuberculosis and M.bovis/BCG strains and identification of PZA-resistant mutant strains of M.tuberculosis were achieved using a protocol to interpret chromatographic patterns produced by TMHA of the test isolates after mixing with the two reference probes.

In order to identify the optimal assay conditions, an extended range of column temperatures and various gradient concentrations were studied. This resulted in a modification of the universal gradient concentration recommended by the manufacturer for mutation detection. The modification process included shortening of the run time from 18 minutes to less than 10 minutes by starting the gradient at higher elution buffer concentration (Buffer B %=61 rather than 40). This change was made based on the predicted retention time of analyzed duplexes according to size. In addition, the slope of elution buffer during the run was reduced from 2% per minute to 1.2% per minute. The modification process also included evaluation of a range of column temperatures starting from the column temperature recommended by the system software of 64.8° C. and ranged up to 66.8° C. in 0.1° C. increment. The optimal column temperature was determined to be 65.8° C. since all higher and lower temperatures failed to induce the production of the predicted chromatographic patterns. These modifications improved the correlation between the predicted chromatographic patterns based on the theoretical helical structure of heteroduplexes of GC rich sequences and the observed patterns.

The essential outcome of these changes was that the previously cryptic mutations within the GC rich sequence of pncA could be revealed. The observed chromatographic patterns following TMHA of the wild type isolates of M.tuberculosis and M.bovis (FIG. 11) were consistent with the predicted patterns on which the study was based and provided for the differentiation between the two closely related members of the MTC.

Given the diversity of pncA mutations that convey PZA resistance, it was important to test mutations from within all regions of the coding sequence, as well as the promoter element. To test the clinical applicability of our assay, 13 different PZA-resistant mutant strains of M.tuberculosis were evaluated. Eleven of these mutant isolates generated the predicted chromatographic pattern, i.e. a double peak pattern with clear demonstration of an intervening trough between the peaks when mixed with both reference probes. Two mutant M.tuberculosis isolates (mutant 3 and mutant 9) did not produce the standard double peak pattern when mixed with M.tuberculosis reference probe. The patterns of mutant isolates 3 and 9 were found to be highly reproducible. Review of the sequence showed that mutant isolates 3 and 9 had mutations in two different regions of pncA with high GC content. This was consistent with the original suggestion by Cooksey et al. (supra), that the difficulty in detecting pncA mutations was due to the presence of GC rich sequences adjacent to the mutated nucleotides. The influence of the GC rich region on the chromatographic pattern generated by mutations within such sequences was subsequently confirmed by analyzing two additional mutant isolates within GC rich regions, (C₄₀₁T) and (G₅₁₁A). Using the same optimized conditions, these mutants produced patterns similar to those of mutant isolate 9 (data not shown). Thus, single point mutations within or near GC rich regions of pncA were unable to disrupt the helical structure of the heteroduplex DNA under the given conditions, rendering them indistinguishable from the homoduplex DNA. Mutations within GC rich regions could be, however, uncovered through an optimal combination of both column temperature and gradient buffer concentration.

Production of chromatographic peaks using TMHA-DHPLC (WAVE™) technology is a function of temperature and the interaction between the DNA duplex and the cartridge matrix under given buffer gradients. It has been reported that the DNASep® cartridge, under nondenaturing conditions, resolves the DNA fragment independent of sequence composition (Hecker, K. H., et al. (2000) J. Biochem. Biophys. Methods. 46:83-93). However, shouldered peaks have been observed with certain GC rich sequences, even under non-denaturing conditions. Specific sequences with predicted secondary structure generated by these GC rich sequences are responsible for these shouldered peaks. At higher temperature and under the optimal gradient concentration used in the present study, the chromatographic patterns generated from mutant isolates mixtures, that contain both homoduplex and heteroduplex populations, were expected to contain double peaks or at least shouldered peaks that were distinguishable from those of wild type isolates that contain only homoduplex populations.

Another important difference between the chromatographs produced by mutant isolates 3 and 9 and those produced by wild type M.tuberculosis isolates was apparent when both were analyzed with the M.bovis reference probe. Mutants 3 and 9 produced chromatographic patterns with two peaks that were separated by a greater distance than that of wild type isolates (FIG. 13B). This increase in peak separation also seen in all other mutant isolates when mixed with M. bovis probe. The generation of widely separated peaks was a function of an earlier elution time for the heteroduplex formed by the mutant DNA in comparison with the heteroduplex formed by the wild type M.tuberculosis DNA. One explanation for this observation is that the mutant heteroduplexes have greater secondary structure than the wild type heteroduplexes. This is due to the presence of two base pair mismatches in the mutant heteroduplex, one in the mutant DNA and one in the M.bovis reference probe, compared to the wild type heteroduplexes that have only a single base pair mismatch that is present in the M.bovis reference probe. The greater secondary structure in the mutant isolates heteroduplexes is believed to result in its earlier elution than the wild type heteroduplexes.

When the observed patterns from both reference probes were considered together, mutants 3 and 9 could be distinguished from wild type M.tuberculosis isolates, a characterization that could not be made if only one probe was utilized in the analysis. Demonstration of the specificity of the current assay was also important since crosscontamination with non-tuberculous Mycobacterium species is a well known problem in other standard culture based automated assays (Leitritz, L., et al. supra; Tortoli, E., et al. supra). Specificity was achieved through the use of specific primers that selectively amplify the pncA target only from the MTC and not from non-tuberculous mycobacteria. The simultaneous screening for PZA resistance and identification of MTC members was generally accomplished within 24 hours of obtaining an isolate. Since PCR can be applied to direct patient specimens such as bronchial wash fluid (Telenti, A., et al. supra), even faster analysis is feasible.

A simpler method of detecting mutations within problematic regions (e.g. mutants 3 and 9) was achieved by generating a mutant M. tuberculosis probe wherein the adenosine at position (−42) has been deleted. This mutant probe allowed for the rapid identification under the modified assay conditions described hereinabove of both mutant species and wild-type (FIG. 14).

The ability to detect mutations within GC rich sequences, essential to the identification of PZA resistance, and the simultaneous ability to distinguish between the closely related Mycobacterium species M. tuberculosis and M. bovis, significantly expands the utility of TMHA-DHPLC methodology for clinical applications.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A method for generating a custom database of sequences comprising:
a) providing a database of sequences;
b) providing at least one sequence region in the database having a highly conserved start sequence and a highly conserved end sequence;
c) providing at least one validation condition for said sequence region;
d) comparing at least one selected input sequence to said at least one validation condition to determine whether the input sequence is a valid input sequence; and
e) adding valid input sequences to the custom database.

2. The method of claim 1, wherein said selected input sequence includes characters constituting wildcards and wherein said at least one validation condition comprises in the input sequence and a threshold for allowable wildcards when adding a sequence.

3. The method of claim 2, wherein said at least one validation condition comprises a threshold for an allowable number of wildcards.

4. The method of claim 1, wherein said at least one validation condition comprises a threshold for the number of characters in a character run in the input sequence.

5. The method of claim 1, wherein said at least one validation condition comprises the presence of the highly conserved start sequence and a highly conserved end sequence in the input sequence.

6. The method of claim 1, including the step of obtaining the at least one input sequence of step d) from an external database.

7. The method of claim 6, wherein said external database is selected from the group of GenBank and TIGR.

8. The method of claim 6, wherein said external database comprises GenBank.

9. The method of claim 1 including the step of performing selected biological identification techniques to identify the at least one selected input sequence and the step of adding the at least one input sequence of step d) from the input sequence identified by the selected biological identification techniques.

10. The method of claim 1, comprising the step of identifying the selected input sequence as an invalid sequence if the input sequence fails to meet the at least one validation condition.

11. A method for generating a custom database of sequences comprising:
a) providing a first database of existing sequences;
b) comparing a selected isolated sequence to the existing sequences in the database;
c) identifying the isolated sequence as a new sequence if the isolated sequence is different from the existing sequences in the first database;
d) comparing the new sequence with an external database of sequences to identify the new sequence as an identified new sequence when the new sequence is the same as one of the sequences in the external database;
e) comparing the identified new sequence with selected validation criteria to determine whether the identified new sequence is a valid new sequence for the first database of sequences; and
f) updating the first database of sequences to include the identified new sequence if the identified new sequence is a valid new sequence.

12. The method of claim 11 including the step of identifying the isolated sequence as an existing sequence if the isolated sequence is the same as one of the existing sequences in the first database.

13. The method of claim 11 wherein the isolated sequence is compared to selected input validation criteria to determine whether the isolated sequence is a proper sequence for comparison to the first database of existing sequences.

14. The method of claim 13 including the step of identifying the isolated sequence as an improper sequence if the isolated sequence fails to meet the selected input validation criteria.

15. The method of claim 13 including the step of identifying the isolated sequence as an existing sequence if the isolated sequence is the same as one of the existing sequences in the final database.

16. The method of claim 11 wherein the step of comparing the new sequence with the external database of sequences includes the step of designating the new sequence to be an unknown sequence if the new sequence is different from the sequences of the external database.

17. The method of claim 16 including the step of performing selected biological identification techniques on a sample containing the unknown sequence to identify the unknown sequence as the identified new sequence if the sample containing the unknown sequence is identifiable from the biological identification techniques.

18. The method of claim 11 wherein the external database includes GenBank.

19. The method of claim 11 wherein the external database is selected from the group of GenBank and TIGR.

20. The method of claim 1, 2, 3, 4, 5, 6, 7, or 8 wherein the step of providing a database of sequences includes the step of providing the database of sequences for the identification of Mycobacterium.

21. The method of claim 1, wherein said at least one input sequence of step d) is obtained through sequencing of at least one region within the genome of identified Mycobacterium isolates.

22. The method of claim 21, wherein said at least one region within the genome is the ITS region and is amplified using a primer set comprising

| | |
|---|---|
| GAAGTCGTAACAAGGTAGCCG and | (SEQ ID NO: 5) |
| GATGCTCGCAACCACTATCCA. | (SEQ ID NO: 6) |

23. The method of claim 21, wherein said at least one region within the genome is the 16S rRNA gene region and is amplified using a primer set comprising

| | |
|---|---|
| TGGCTCAGGACGAACGCTGG and | (SEQ ID NO: 7) |
| ACAACGCTCGCACCCTACG. | (SEQ ID NO: 8) |

24. The method of claim 1, wherein said at least one sequence region of step b) is the 16S rRNA gene comprising the highly conserved start sequence GTCGAACGG (SEQ ID NO: 1) and the highly conserved end sequence GGCCAACTACGT (SEQ ID NO: 2).

25. The method of claim 1, wherein said at least one sequence region of step b) is the ITS region located between the 16S and 23S genes of the ribosomal gene cluster comprising the highly conserved start sequence CACCTCCTTTCT (SEQ ID NO: 3) and the end sequence GGGGTGTGG (SEQ ID NO: 4).

26. The method of claim 1, wherein said at least one sequence region of step b) include the ITS region located between the 16S and 23S genes of the ribosomal gene cluster comprising the highly conserved start sequence CACCTCCTTTCT (SEQ ID NO: 3) and the end sequence GGGGTGTGG (SEQ ID NO: 4) and the 16S rRNA gene comprising the highly conserved start sequence GTCGAACGG (SEQ ID NO: 1) and the highly conserved end sequence GGCCAACTACGT (SEQ ID NO: 2).

27. The custom database generated by the method of claim 1.

28. The custom database generated by the method of claim 20.

29. A method of searching a custom database of sequences to identify an unknown sample comprising:
a) obtaining a unknown sequence from said unknown sample;
b) selecting custom database sequence regions of the database to be searched;
c) validating the unknown sequence against selected custom database validation conditions;
d) returning an error message if said unknown sequence fails the validation conditions;
e) comparing the unknown sequence to the selected database sequence regions;
f) computing similarity scores for each selected region of said unknown sequence relative to the custom database sequence regions to determine the similarity thereof if the unknown sequence is valid; and
g) sorting the similarity scores from highest to lowest.

30. The method of claim 29, wherein the unknown sample is from the genus Mycobacterium.

31. The method of claim 30, wherein said sequence from said unknown sample is obtained by amplification of the ITS region with a primer set comprising

| | |
|---|---|
| GAAGTCGTAACAAGGTAGCCG and | (SEQ ID NO: 5) |
| GATGCTCGCAACCACTATCCA. | (SEQ ID NO: 6) |

32. The method of claim 20, wherein said sequence from said unknown sample is obtained by amplification of the 16S rRNA region with a primer set comprising

| | |
|---|---|
| TGGCTCAGGACGAACGCTGG and | (SEQ ID NO: 7) |
| ACAACGCTCGCACCCTACG. | (SEQ ID NO: 8) |

33. A method for identifying a sample as M. tuberculosis or M. bovis in a biological sample comprising:
a) obtaining a sample suspected of containing M. tuberculosis or M. bovis;
b) amplifying a nucleic acid comprising the pcnA gene region from said sample;
c) mixing the amplified nucleic acid of step b) with a M. tuberculosis probe and with a M. bovis probe such that hybridization occurs and forms polynucleotide complexes;
d) subjecting formed complexes to denaturing high performance liquid chromatography; and
e) analyzing the peak pattern of the eluates to determine whether said sample is M. tuberculosis or M. bovis.

34. The method of claim 33 wherein said M. tuberculosis probe comprises SEQ ID NO: 19.

35. The method of claim 33 wherein said M. tuberculosis probe comprises SEQ ID NO: 21.

36. The method of claim 33 wherein said M. bovis probe comprises SEQ ID NO: 20.

37. A method for determining the PZA resistance status of a Mycobacterium in a biological sample comprising:
a) obtaining a sample suspected of containing M. tuberculosis or M. bovis;
b) amplifying a nucleic acid comprising the pcnA gene region from said sample;
c) mixing the amplified nucleic acid of step b) with a M. tuberculosis probe and with a M. bovis probe such that hybridization occurs and forms polynucleotide complexes;
d) subjecting formed complexes to denaturing high performance liquid chromatography; and
e) analyzing the peak pattern of the eluates to determine the PZA resistance status of said Mycobacterium sample.

38. The method of claim 37 wherein said M. tuberculosis probe comprises SEQ ID NO: 19.

39. The method of claim 37 wherein said M. tuberculosis probe comprises SEQ ID NO: 21.

40. The method of claim 37 wherein said M. bovis probe comprises SEQ ID NO: 20.

41. A method for determining the PZA resistance status of a Mycobacterium and identifying a sample as M. tuberculosis or M. bovis in a biological sample comprising:
a) obtaining a sample suspected of containing M. tuberculosis or M. bovis;
b) amplifying a nucleic acid comprising the pcnA gene region from said sample;
c) mixing the amplified nucleic acid of step b) with a M. tuberculosis probe and with a M. bovis probe such that hybridization occurs and forms polynucleotide complexes;
d) subjecting formed complexes to denaturing high performance liquid chromatography; and
e) analyzing the peak pattern of the eluates to determine the PZA resistance status of said Mycobacterium sample and whether said sample is M. tuberculosis or M. bovis.

42. The method of claim 37 wherein said M. tuberculosis probe comprises SEQ ID NO: 19.

43. The method of claim 37 wherein said M. tuberculosis probe comprises SEQ ID NO: 21.

44. The method of claim 37 wherein said M. bovis probe comprises SEQ ID NO: 20.
